(19) United States
(12) Patent Application Publication
(10) Pub. No.: US 2023/0222534 A1
(43) Pub. Date: Jul. 13, 2023

(54) INFORMATION PROVIDING METHOD

(71) Applicant: Panasonic Intellectual Property Management Co., Ltd., Osaka (JP)

(72) Inventors: HIROSHI YAHATA, Osaka (JP); TAKAHIRO NISHI, Nara (JP); TADAMASA TOMA, Osaka (JP); TOSHIYASU SUGIO, Osaka (JP)

(21) Appl. No.: 18/051,903

(22) Filed: Nov. 2, 2022

Related U.S. Application Data
(63) Continuation of application No. PCT/JP2020/026583, filed on Jul. 7, 2020.

(30) Foreign Application Priority Data
May 28, 2020 (JP) 2020-093770

(51) Int. Cl. G06Q 30/0235; G01S 1/04; G06Q 30/0601

(52) U.S. Cl. CPC G06Q 30/0235; G01S 1/045; G06Q 30/0641

(57) ABSTRACT

A beacon signal transmitter is disposed in a store. A first communication terminal within a reception range of a beacon signal transmitted from the beacon signal transmitter receives the beacon signal. The first communication terminal receives a push notification corresponding to the store from a store management system. The first communication terminal issues, based on the push notification, a request for a purchase menu corresponding to the store. Based on limited product information and the request for the purchase menu, privileged purchase menu information in which a limited product indicated by the limited product information is added to the purchase menu is generated. The privileged purchase menu information is output to the first communication terminal.

### BACKGROUND

### 1. Technical Field

The present disclosure relates to a store management system connected to a store terminal.

### 2. Description of the Related Art

In recent years, there has been proposed a service for notifying an advertisement from a store to a mobile terminal of a user in the store. For example, Japanese Unexamined Patent Publication No. 2017-37574 discloses an advertisement providing system for realizing push notifications of advertisements at a frequency appropriate for a user and capable of maintaining advertisement effects.

### SUMMARY

However, there has been a need for further improvement in Japanese Unexamined Patent Publication No. 2017-37574.

In one general aspect, the techniques disclosed here feature a method for a store management system connected to a store terminal, the method including: acquiring, from the store terminal via a network, limited product information indicating a limited product for which a time available for sale in a store corresponding to the store terminal is limited; acquiring, from a first communication terminal of a first user via the network, a request for a purchase menu corresponding to the store in which a beacon signal transmitter is disposed, wherein the first communication terminal within a reception range of a beacon signal transmitted from the beacon signal transmitter receives the beacon signal, the first communication terminal starts communication with the store management system in response to reception of the beacon signal, the first communication terminal receives a push notification corresponding to the store from the store management system, and the first communication terminal issues, based on the push notification, the request for the purchase menu corresponding to the store; generating, based on the limited product information and the request for the purchase menu, privileged purchase menu information in which the limited product indicated by the limited product information is added to the purchase menu; and outputting the privileged purchase menu information to the first communication terminal.

According to the present disclosure, further improvement can be achieved.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating an example of an overall configuration of an information providing system according to a first embodiment;

FIG. 2 is a block diagram illustrating an example of a detailed configuration of the information providing system according to the first embodiment;

FIG. 3 is an explanatory diagram relating to a beacon signal;

FIG. 4 is a diagram illustrating an example of a data configuration of a store dictionary;

FIG. 5 is a diagram illustrating an example of the data configuration of the store dictionary;

FIGS. 6A and 6B are a sequence diagram illustrating an example of a process performed by the information providing system according to the first embodiment;

FIGS. 7A and 7B are a sequence diagram illustrating another example of the process performed by the information providing system according to the first embodiment;

FIG. 8 is a diagram illustrating an example of an initial screen of a business operator X application;

FIG. 9 is a diagram illustrating an example of a map screen;

FIG. 10 is a screen diagram illustrating an example of a standard purchase menu;

FIG. 11 is a diagram illustrating a standard purchase menu in which an order field is superimposed and displayed;

FIG. 12 is a diagram illustrating an example of an order history screen;

FIG. 13 is a diagram illustrating an example of an order detail screen;

FIG. 14 is a diagram illustrating an example of a display screen on which a push notification is displayed;

FIG. 15 is a screen diagram illustrating an example of a privileged purchase menu;

FIG. 16 is a diagram illustrating an order confirmation screen displayed on an information terminal;

FIG. 17 is a diagram illustrating an example of an order status screen displayed on a display device;

FIG. 18 is a diagram illustrating an example of the order status screen displayed on the display device;

FIG. 19 is a flowchart illustrating details of the process performed by the information providing system according to the first embodiment;

FIGS. 20A and 20B are a sequence diagram illustrating an example of a process performed by an information providing system according to a second embodiment;

FIGS. 21A and 21B are a sequence diagram illustrating another example of the process performed by the information providing system according to the second embodiment;

FIG. 22 is a diagram illustrating an example of an initial screen in the second embodiment;

FIG. 23 is a screen diagram illustrating an example of a standard advertisement;

FIG. 24 is a diagram illustrating an example of a display screen on which a push notification is displayed in the second embodiment;

FIG. 25 is a screen diagram illustrating an example of a privileged advertisement;

FIG. 26 is a diagram illustrating an example of an advertisement screen displayed on the display device;

FIG. 27 is a flowchart illustrating details of the process performed by the information providing system according to the second embodiment;

FIGS. 28A and 28B are a sequence diagram illustrating an example of a process performed by an information providing system according to a third embodiment;

FIGS. 29A and 29B are a sequence diagram illustrating another example of the process performed by the information providing system according to the third embodiment;

FIGS. 30A and 30B are a sequence diagram illustrating an example of a process performed by an information providing system according to a fourth embodiment; and

FIGS. 31A and 31B are a sequence diagram illustrating another example of the process performed by the information providing system according to the fourth embodiment.

### DETAILED DESCRIPTIONS

### Underlying Knowledge Forming Basis of the Present Disclosure

In a store, a limited product for which a remaining time during which the product can be sold or a time slot during which the product can be sold (hereinafter, referred to as “time available for sale”) is limited may be present. For example, in a supermarket, there are cases where unsold products are sold at a special price immediately before the closing of the store, or foods specially delivered on the day are sold at a special price during a limited sales time slot.

In addition, a fast-food store provides a service of receiving an order from a user via a mobile terminal from outside the store and providing a freshly cooked food to the user when the user visits the store. However, the user may cancel the food after the order. If such a food is sold at a special price as a limited product without being discarded, food waste can be expected to be prevented.

Japanese Unexamined Patent Publication No. 2017-37574 discloses that a push notification of an advertisement is displayed on a display of an information terminal that has received a beacon signal from a store. However, in Japanese Unexamined Patent Publication No. 2017-37574, the advertisement displayed on the display of the information terminal is merely an electronic advertisement of a paper medium, and there is room for further improvement in notifying the limited product.

Japanese Unexamined Patent Publication No. 2017-37574 further discloses that a push notification of an advertisement is displayed on a display of an information terminal on condition that a notification waiting time has elapsed after a user carrying the information terminal enters a shopping mall. However, in Japanese Unexamined Patent Publication No. 2017-37574, the user is not notified of the advertisement unless the notification waiting time has elapsed after the user entered the shopping mall. Therefore, it is not possible to timely notify the user of the limited product, and there is room for further improvement.

Based on the above findings, the present inventors have conceived the following aspects according to the present disclosure.

A method according to an aspect of the present disclosure is a method for a store management system connected to a store terminal, the method including: acquiring, from the store terminal via a network, limited product information indicating a limited product for which a time available for sale in a store corresponding to the store terminal is limited; acquiring, from a first communication terminal of a first user via the network, a request for a purchase menu corresponding to the store in which a beacon signal transmitter is disposed, wherein the first communication terminal within a reception range of a beacon signal transmitted from the beacon signal transmitter receives the beacon signal, the first communication terminal starts communication with the store management system in response to reception of the beacon signal, the first communication terminal receives a push notification corresponding to the store from the store management system, and the first communication terminal issues, based on the push notification, the request for the purchase menu corresponding to the store; generating, based on the limited product information and the request for the purchase menu, privileged purchase menu information in which the limited product indicated by the limited product information is added to the purchase menu; and outputting the privileged purchase menu information to the first communication terminal.

According to this configuration, the limited product information indicating the limited product for which the time available for sale is limited is acquired, the push notification is displayed to a person who is within the reception range of the beacon signal from the store, and, in response to the request for the purchase menu based on the push notification, the privileged purchase menu including the limited product is displayed.

Thus, for example, it is possible to timely provide information about the limited product, which changes from moment to moment depending on stock or time, to a person in the store or in the vicinity of the store through the first communication terminal.

According to the present disclosure, the following effects are obtained when the limited product is a food whose commercial value significantly decreases with time, for example, a packed meal immediately before the best-before date.

That is, it is possible to reduce the food loss of foods provided by the store by displaying the menu including the limited product via the first communication terminal to a person who is in the vicinity of the store and is likely to promptly pick up the limited product, that is, a person who is within the reception range of the beacon signal from the store. When the limited product is inexpensive, the user can obtain the limited product at a low price.

Furthermore, according to this configuration, the purchase menu information is generated in response to the request for the purchase menu based on the push notification and is output to the first communication terminal. Therefore, the purchase menu is prevented from being displayed on the first communication terminal against the will of the user, and the user can be prevented from being bothered.

The method may further include: acquiring, from the store terminal, sold-out information indicating that the limited product has been sold out in the store; acquiring, from a second communication terminal of a second user, a request for the purchase menu corresponding to the store, wherein the second communication terminal within the reception range of the beacon signal receives the beacon signal, the second communication terminal starts communication with the store management system in response to reception of the beacon signal, the second communication terminal receives a push notification corresponding to the store from the store management system, and the second communication terminal issues, based on the push notification, the request for the purchase menu corresponding to the store; and outputting, based on the sold-out information and the request for the purchase menu, standard purchase menu information corresponding to the store to the second communication terminal, the standard purchase menu information not including the limited product.

According to this configuration, in response to the request for the purchase menu from a user in the vicinity of the store or a user in the store, if the limited product is sold out, a standard purchase menu not including the limited product is displayed. Therefore, it is possible to prevent the privileged purchase menu from being displayed even if the limited product is sold out.

In the method, the beacon signal may include a beacon identifier (ID), and the first communication terminal may start communication with the store management system using an application for communicating with the store management system corresponding to the beacon ID.

According to this configuration, it is possible to communicate with the store management system only by installing an application for communicating with the store management system corresponding to the beacon ID in the first communication terminal.

In the method, the beacon signal may include a uniform resource locator (URL) for accessing the store management system, and the first communication terminal may start communication with the store management system using the URL.

Since the URL is included in the beacon signal, for example, the first communication terminal can communicate with the store management system using an existing Internet browser.

In the method, a monitor connected to the store terminal may be disposed in the store, and the store management system may acquire the limited product information from the store terminal in synchronization with a first instruction to display on the monitor the limited product information. The first instruction is output from the store terminal to the monitor.

According to this configuration, when the limited product information is notified through the monitor in the store, it is possible to cause the store management system to promptly acquire the limited product information, and it is possible to prevent occurrence of a time lag regarding acquisition of the limited product information in the store terminal and the store management system.

In the method, a monitor connected to the store terminal may be disposed in the store, and the sold-out information may be acquired from the store terminal in synchronization with a second instruction to erase a display of the limited product information from the monitor. The second instruction is output from the store terminal to the monitor.

According to this configuration, when the limited product information is deleted from the monitor in the store, it is possible to promptly notify this to the store management system, and it is possible to prevent occurrence of a time lag regarding deletion of the limited product information in the store terminal and the store management system.

In the method, the time available for sale may be shorter than 24 hours.

According to this configuration, it is possible to prevent a product whose freshness is degraded from being handled as a limited product.

A method according to another aspect of the present disclosure is a method for a store management system connected to a store terminal, the method including: acquiring, from the store terminal via a network, limited product information indicating a limited product for which a time available for sale in a store corresponding to the store terminal is limited; acquiring, from a first communication terminal of a first user via the network, a request for a purchase menu corresponding to the store in which a beacon signal transmitter is disposed, wherein the first communication terminal within a reception range of a beacon signal transmitted from the beacon signal transmitter receives the beacon signal, the first communication terminal starts communication with the store management system in response to reception of the beacon signal, the first communication terminal receives a push notification corresponding to the store from the store management system, and the first communication terminal issues, based on the push notification, the request for the purchase menu corresponding to the store; generating, based on the limited product information, privileged purchase menu information in which the limited product indicated by the limited product information is added to the purchase menu; and outputting, based on the request for the purchase menu, the privileged purchase menu information to the first communication terminal.

According to this configuration, upon reception of the request for the purchase menu, the privileged purchase menu information generated in advance based on the limited product information can be transmitted, and thus, it is possible to save the time and effort to generate the privileged purchase menu information each time the request for the purchase menu is acquired.

A method according to still another aspect of the present disclosure is a method for a store management system connected to a store terminal, the information providing method including: acquiring, from the store terminal via a network, limited product information indicating a limited product for which a time available for sale in a store corresponding to the store terminal is limited; acquiring, from a first communication terminal of a first user via the network, a request for an advertisement corresponding to the store in which a beacon signal transmitter is disposed, wherein the first communication terminal within a reception range of a beacon signal transmitted from the beacon signal transmitter receives the beacon signal, the first communication terminal starts communication with the store management system in response to reception of the beacon signal, the first communication terminal receives a push notification corresponding to the store from the store management system, and the first communication terminal issues, based on the push notification, the request for the advertisement corresponding to the store; generating, based on the limited product information and the request for the advertisement, privileged advertisement information of the store, the privileged advertisement information including the limited product; and outputting the privileged advertisement information to the first communication terminal.

According to this configuration, the limited product information indicating the limited product for which the time available for sale is limited is acquired via the network, the push notification is displayed to a person who is within the reception range of the beacon signal from the store, and, in response to the advertisement request based on the push notification, a privileged advertisement including the limited product is displayed.

Thus, for example, it is possible to timely provide information about the limited product, which changes from moment to moment depending on stock or time, to a person in the store or in the vicinity of the store through the first communication terminal.

According to the present disclosure, the following effects are obtained when the limited product is a food whose commercial value significantly decreases with time, for example, a packed meal immediately before the best-before date.

That is, it is possible to reduce the food loss of foods provided by the store by displaying the advertisement including the limited product via the first communication terminal to a person who is in the vicinity of the store and is likely to promptly pick up the limited product, that is, a person who is within the reception range of the beacon signal from the store. When the limited product is inexpensive, the user can obtain the limited product at a low price.

Furthermore, according to this configuration, the advertisement information is generated in response to the request for the advertisement corresponding to the store based on the push notification and is output to the first communication terminal. Therefore, the advertisement is prevented from being displayed on the first communication terminal against the will of the user, and the user can be prevented from being bothered.

The method may further include: acquiring, from the store terminal, sold-out information indicating that the limited product has been sold out in the store; acquiring, from a second communication terminal of a second user, a request for the advertisement corresponding to the store, wherein the second communication terminal within the reception range of the beacon signal receives the beacon signal, the second communication terminal starts communication with the store management system in response to reception of the beacon signal, the second communication terminal receives a push notification corresponding to the store from the store management system, and the second communication terminal issues, based on the push notification, the request for the advertisement corresponding to the store; and outputting, based on the sold-out information and the request for the advertisement, standard advertisement information corresponding to the store to the second communication terminal, the standard advertisement information not including the limited product.

According to this configuration, in response to the request for the advertisement from a user in the vicinity of the store or a user in the store, if the limited product is sold out, a standard advertisement not including the limited product is displayed. Therefore, it is possible to prevent the privileged advertisement from being displayed even if the limited product is sold out.

A method according to still another aspect of the present disclosure is a method for a store management system connected to a store terminal, the information providing method including: acquiring, from the store terminal via a network, limited product information indicating a limited product for which a time available for sale in a store corresponding to the store terminal is limited; acquiring, from a first communication terminal of a first user via the network, a request for an advertisement corresponding to the store in which a beacon signal transmitter is disposed, wherein the first communication terminal within a reception range of a beacon signal transmitted from the beacon signal transmitter receives the beacon signal, the first communication terminal starts communication with the store management system in response to reception of the beacon signal, the first communication terminal receives a push notification corresponding to the store from the store management system, and the first communication terminal issues, based on the push notification, the request for the advertisement corresponding to the store; generating, based on the limited product information, privileged advertisement information of the store, the privileged advertisement information including the limited product indicated by the limited product information; and outputting, based on the request for the advertisement, the privileged advertisement information to the first communication terminal.

According to this configuration, it is possible to transmit the privileged advertisement information generated in advance based on the limited product information when the request for the advertisement is received, and it is possible to save the time and effort to generate the privileged advertisement information each time the request for the advertisement is acquired.

### First Embodiment

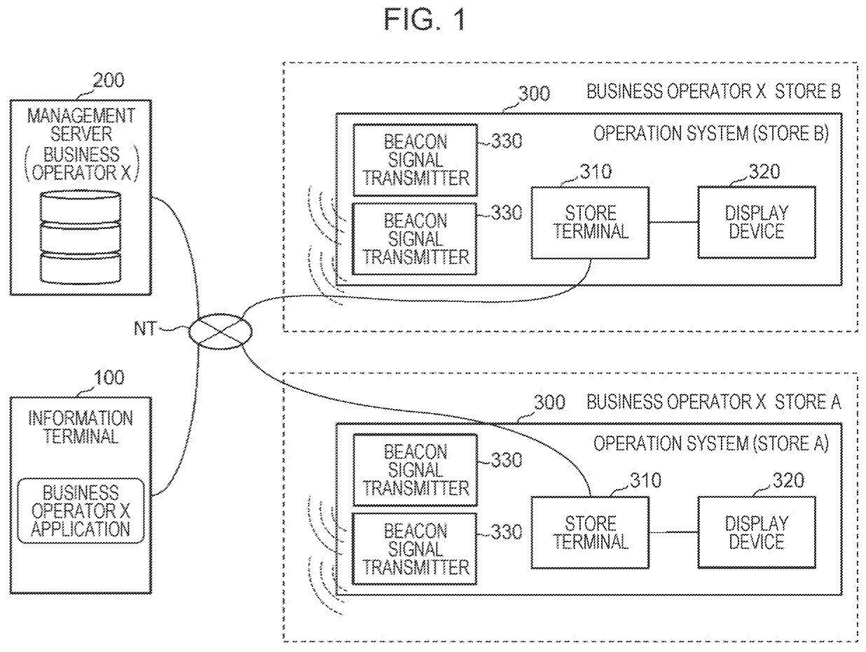

FIG. 1 is a block diagram illustrating an example of the overall configuration of an information providing system according to a first embodiment. The information providing system includes an information terminal 100, a management server 200 (an example of a store management system), and an operation system 300. The information terminal 100, the management server 200, and the operation system 300 are communicably connected to each other via a network NT. The network NT is configured by a wide area communication network including, for example, the Internet and a mobile phone communication network. The information terminal 100 is an example of a first communication terminal, a second communication terminal, and a third communication terminal.

The information terminal 100 is configured by a mobile information processing device such as a smartphone or a tablet terminal. The information terminal 100 is carried by a user to whom a service of a business operator X is provided. This service causes the information terminal 100 to display a purchase menu for purchasing a product that the store of the business operator X sells, and allows the user to purchase the product via the purchase menu. Application software of the business operator X (hereinafter referred to as a business operator X application) is installed in the information terminal 100. The business operator X application is application software for providing a service of the business operator X to a user.

The management server 200 is a cloud server composed of one or more computers. The management server 200 manages the types and stocks of products that the business operator X sells in stores, generates a purchase menu and causes the information terminal 100 to display the purchase menu, and receives an order from a user via the purchase menu.

A store A and a store B belong to the business operator X. The business operator X is a company that manages the store A and the store B. In this embodiment, the business operator X is a business operator that develops a fast-food chain such as a hamburger shop or a coffee shop. Therefore, the store A and the store B are stores belonging to the fast-food chain developed by the business operator X. In the example in FIG. 1, two stores, which are the store A and the store B, are illustrated, but this is an example, and the number of stores managed by the business operator X may be three or more, or one. The business managed by the business operator X is not limited to fast food, and may be a business for manufacturing and selling packed meals, or may be a ready-made meal business for manufacturing and selling delicatessen and the like. Therefore, the products that the store sells in this embodiment are foods and drinks such as hamburgers, coffees, sweets, delicatessen, Sushi, packed meals, fruit juices, etc.

One or more operation systems 300 are present corresponding to each store. In the example in FIG. 1, two operation systems 300 respectively corresponding to the store A and the store B are illustrated. Each of the operation systems 300 is installed in a corresponding store, and performs product management, employee management, and the like in the corresponding store.

The operation system 300 includes a store terminal 310, a display device 320 (an example of a monitor), and a beacon signal transmitter 330. The store terminal 310 is configured by, for example, a desktop computer or a mobile information processing device such as a smartphone or a tablet terminal, and performs product management and employee management in the corresponding store. The store terminal 310 is connected to the management server 200 via the network NT, and transmits, to the management server 200 at any time, information such as the stock quantity of products that the store sells. The store terminal 310 generates information to be displayed on the display device 320 and outputs the information to the display device 320, and thereby, the information is displayed.

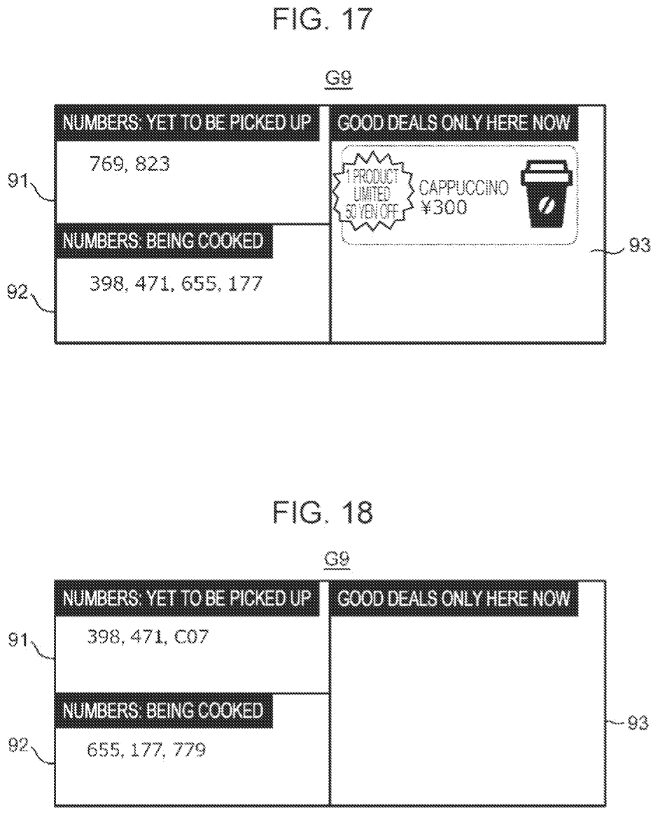

The display device 320 is constituted by, for example, a large-screen display device installed in a store front, and presents various kinds of information to users who visit the store. For example, under the control of the store terminal 310, the display device 320 displays screens for displaying the status of products ordered by the store illustrated in FIG. 17 and FIG. 18. Furthermore, when a limited product is generated due to the cancellation of an ordered product, the display device 320 displays information indicating the generation of the limited product. In this embodiment, the time available for sale of the limited product is shorter than 24 hours. The time available for sale may be, for example, shorter than 12 hours, shorter than 6 hours, shorter than 3 hours, shorter than 1 hour, shorter than 30 minutes, shorter than 15 minutes, shorter than 10 minutes, or shorter than 5 minutes. Note that different time periods may be set as the time available for sale according to the limited product.

The beacon signal transmitter 330 is installed in a store and transmits a beacon signal. One or more beacon signal transmitters 330 are disposed in the store or around the store so that, for example, a main area or all areas in the store and/or an area within a certain range around the store can fall within a communication range. As the beacon signal, a signal conforming to Bluetooth (registered trademark) can be adopted. However, this is an example. As the beacon signal, it is possible to adopt an infrared beacon signal, a wireless communication method that covers a relatively wide area with low power consumption called low power wide area (LPWA), a wireless communication method using a frequency of a 900 MHz level, which is less susceptible to an obstacle with low power consumption called Wireless Smart Utility Network (Wi-SUN), Wi-Fi (registered trademark), or a cellular network for mobile phones.

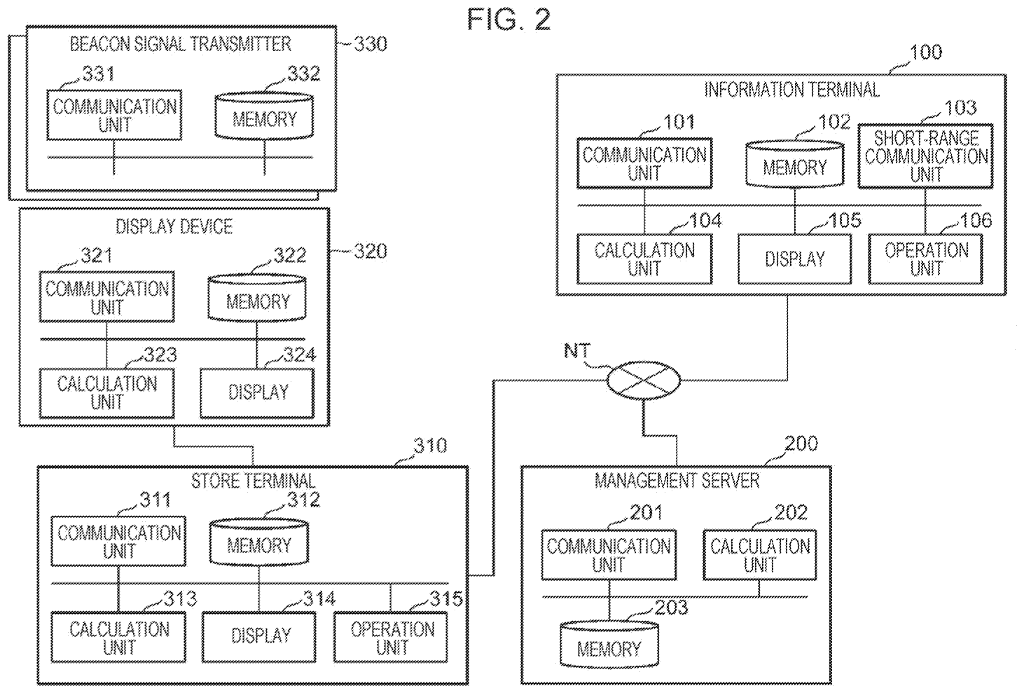

FIG. 2 is a block diagram illustrating an example of a detailed configuration of the information providing system according to the first embodiment. The information terminal 100 includes a communication unit 101, a memory 102, a short-range communication unit 103, a calculation unit 104, a display 105, and an operation unit 106.

The communication unit 101 is configured by, for example, a communication circuit for connecting the information terminal 100 to the network NT. The communication unit 101 transmits, for example, a beacon reception notification to the management server 200, the beacon reception notification indicating that a beacon signal has been received. The communication unit 101 receives, for example, a push notification transmitted from the management server 200. The communication unit 101 transmits, to the management server 200, for example, a store identifier (ID) of a store corresponding to the received beacon signal, “beacon reception: successful” indicating that the beacon signal has been successfully received in the store, and a menu request by which a user desires to acquire purchase menu information. The communication unit 101 transmits, to the management server 200, order information indicating a product ordered by the user via the purchase menu.

The memory 102 is configured by a nonvolatile storage device such as a flash memory. The memory 102 stores, for example, a store dictionary for specifying a store (store ID) in which the beacon signal transmitter 330 is installed from a device ID of the beacon signal transmitter 330 included in the beacon signal.

The short-range communication unit 103 is configured by a communication circuit for performing short-range communication such as Bluetooth (registered trademark). The short-range communication unit 103 receives a beacon signal transmitted from the beacon signal transmitter 330.

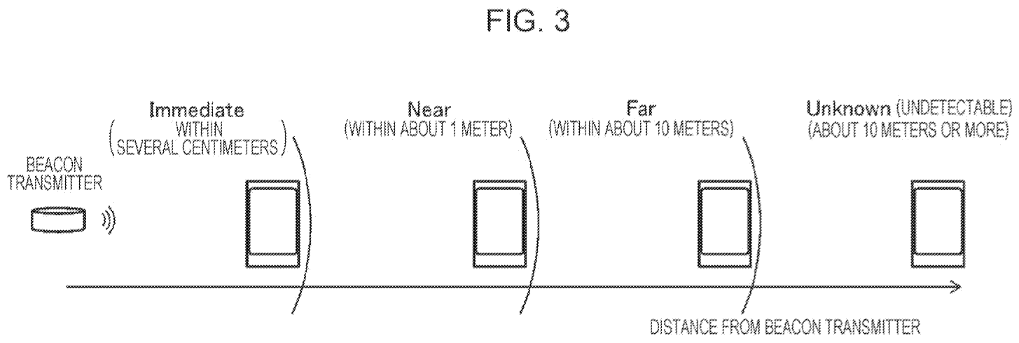

The calculation unit 104 is configured by a processor such as a central processing unit (CPU), and controls the entire information terminal 100. The calculation unit 104 may determine that the reception of a beacon signal has been failed if the detection result of the beacon signal by the short-range communication unit 103 is, for example, “Unknown” illustrated in FIG. 3, and may determine that the reception of a beacon signal has been successful if the detection result is other than “Unknown”. For example, the calculation unit 104 performs a process of specifying the store ID corresponding to the device ID included in the beacon signal received by the short-range communication unit 103 with reference to the store dictionary stored in the memory 102.

The display 105 is configured by a display device such as a liquid crystal panel or an organic electroluminescent (EL) panel. The display 105 displays a purchase menu for users to order products of the store. The operation unit 106 includes, for example, a touch panel, and receives instructions from users. For example, the operation unit 106 receives an instruction to select a push notification or an order instruction in which the user issues an instruction to order a product via the purchase menu.

The management server 200 includes a communication unit 201, a calculation unit 202, and a memory 203. The communication unit 201 is configured by a communication circuit that connects the management server 200 to the network NT. The communication unit 201 receives, for example, a beacon reception notification transmitted from the information terminal 100. For example, the communication unit 201 receives the store ID, “beacon reception: successful”, and the menu request, and receives order information indicating the order content. Furthermore, the communication unit 201 transmits purchase menu information for causing the information terminal 100 to display the purchase menu. The purchase menu information may include, for example, layout information for specifying a display position or the like of a graphical user interface (GUI) component constituting the purchase menu and/or various image data of the GUI component. As will be described later, there are two types of purchase menu information, which are privileged purchase menu information and standard purchase menu information. Furthermore, the communication unit 201 receives, from the store terminal 310, limited product information indicating a limited product for which the time available for sale in the store corresponding to the store terminal 310 is limited. Furthermore, the communication unit 201 receives sold-out information indicating that the limited product has been sold out in the store.

The calculation unit 202 is configured by a processor such as a CPU, and controls the entire management server 200. The calculation unit 202 receives, via the communication unit 201, the limited product information indicating the limited product for which the time available for sale in the store corresponding to the store terminal 310 is limited. In a case where the limited product information of a certain store is received, upon reception of the beacon reception notification corresponding to the store from the information terminal 100 via the short-range communication unit 103, the calculation unit 202 transmits a push notification corresponding to the store to the information terminal 100 via the communication unit 201. Upon reception of the store ID of the store corresponding to the push notification, “beacon reception: successful”, and the menu request from the information terminal 100 via the communication unit 201, the calculation unit 202 determines to transmit privileged purchase menu information in which the limited product indicated by the limited product information is added to a standard purchase menu of the store indicated by the store ID, and transmits the privileged purchase menu information to the information terminal 100 via the communication unit 201.

The memory 203 stores, for example, a product database that manages products that each store sells and the stock quantity of the products. The memory 203 stores, for example, a purchase history database that manages a purchase history of products that each store sells.

The store terminal 310 includes a communication unit 311, a memory 312, a calculation unit 313, a display 314, and an operation unit 315. The communication unit 311 is configured by a communication circuit that connects the store terminal 310 to the network NT. The communication unit 311 transmits the limited product information and the sold-out information to the management server 200. Note that the store terminal 310 and the display device 320 are connected to each other via, for example, a local area network. Therefore, the communication unit 311 may have a communication function of communicating with the display device 320 via the local area network.

The memory 312 stores, for example, a store product database, for each store, which manages the types of products that the store sells, the stock quantity of the products, and the like. The memory 312 stores, for example, a work database that manages work statuses, work schedules, actual working hours, and the like of employees of the store.

The calculation unit 313 is configured by a processor such as a CPU. In a case where an input instruction (an example of a first instruction) for displaying the limited product information on the display device 320 from an employee of the store is acquired, or in a case where the generation of a limited product due to cancellation of an order or the like is detected, the calculation unit 313 outputs a command and/or display data for displaying the limited product information to the display device 320. The calculation unit 313 transmits the limited product information to the management server 200 in synchronization with the output of the command and/or display data for displaying the limited product information. Thus, the management server 200 can acquire the limited product information in synchronization with the input instruction for displaying the limited product information or at the same time as the calculation unit 313 detecting the generation of the limited product.

In a case where an input instruction (an example of a second instruction) for deleting the limited product information, which is displayed, is acquired, or in a case where it is detected that the limited product is sold out, the calculation unit 313 outputs a command and/or display data for deleting the limited product information to the display device 320. In synchronization with the output of the command and/or display data for deleting the limited product information, the calculation unit 313 transmits, to the management server 200, the sold-out information indicating that the product indicated by the limited product information is sold out. Thus, the management server 200 can acquire the sold-out information in synchronization with the input instruction for deleting the limited product information or at the same time as the calculation unit 313 detecting that the limited product is sold out.

The display 314 is configured by a display device such as a liquid crystal panel or an organic EL panel. The operation unit 315 includes input devices such as a keyboard and a mouse. The operation unit 315 acquires an input instruction for displaying the limited product information and an input instruction for deleting the limited product information input by an employee. Note that the operation unit 315 may also include a touch panel.

The display device 320 includes a communication unit 321, a memory 322, a calculation unit 323, and a display 324. The communication unit 321 is configured by a communication circuit for connecting the display device 320 to a local area network. The communication unit 321 receives, from the store terminal 310, a command and/or display data for displaying the limited product information and a command and/or display data for deleting the limited product information.

The memory 322 stores image data and the like to be displayed on the display 324. The calculation unit 323 is configured by a processor such as a CPU. The calculation unit 323 causes the display 324 to display the limited product information upon acquisition of the command and/or display data for displaying the limited product information, and deletes the limited product information from the display 324 upon acquisition of the command and/or display data for deleting the limited product information. The display 324 is configured by a display device such as a liquid crystal panel, an organic EL panel, or a projector and displays the limited product information and the like under the control of the calculation unit 323.

The beacon signal transmitter 330 is, for example, a transmitter conforming to the Bluetooth Low Energy (BLE) standard, and includes a communication unit 331 and a memory 332. The communication unit 331 periodically transmits a beacon signal including the device ID stored in the memory 332. The beacon signal is used to detect and determine whether a certain user carrying the information terminal 100 in which the business operator X application is installed is present in a certain store or in the vicinity of the store. There is a case where the store is larger than the reach range of the beacon signal. In this case, by installing a plurality of beacon signal transmitters 330 in the store, it is possible to detect and determine that the user is in the store or in the vicinity of the store without exception.

The memory 332 is configured by a rewritable nonvolatile storage device such as a flash memory, and stores a device ID for uniquely specifying the beacon signal transmitter 330.

FIG. 3 is an explanatory diagram relating to a beacon signal. A platform called iBeacon (registered trademark) is known as a standard of the beacon signal, and iBeacon is illustrated in the example in FIG. 3. In iBeacon, the distance between the beacon signal transmitter 330 and the information terminal 100 is measured based on the radio wave intensity when the information terminal 100 receives the beacon signal. In iBeacon, the measured distance may be roughly classified into four types: Immediate, Near, Far, and Unknown. For example, Immediate indicates that the distance between the beacon signal transmitter 330 and a smartphone is within several centimeters; Near indicates that the distance is within about 1 m; Far indicates that the distance is within about 10 m; and Unknown indicates that the distance is greater than or equal to about 10 m and a beacon signal is undetectable.

The beacon signal includes a universally unique identifier (UUID). A service or the like can be identified by embedding unique data in the UUID. As a setting format of the value of the UUID, for example, a format conforming to ISO/IEC11578 can be adopted.

Since a UUID is used for identification of a service or the like in iBeacon, the information terminal 100 is incapable of responding to a beacon signal unless a smartphone application that knows a beacon ID or the like is installed in the information terminal 100. Therefore, it is necessary to install in advance a smartphone application corresponding to the UUID of a specific beacon signal in the information terminal 100 in iBeacon. The smartphone application is an example of an application that communicates with the store management system (management server 200) corresponding to the beacon ID (device ID) in the first communication terminal (information terminal 100).

Another known platform for beacon signals is Eddystone (registered trademark). Eddystone includes a UID type and a URL type. In the UID type, since the beacon ID is transmitted as in iBeacon, it is necessary to install in advance an application corresponding to the beacon ID in the information terminal 100. In the URL type, a chrome browser can automatically designate a URL to access. Therefore, in a case of the URL type, the information terminal 100 only needs to have a chrome browser, and does not need to have an application corresponding to a specific beacon ID. This URL is included in the beacon signal. This URL is an example of a URL for the information terminal 100 to access the store management system (management server 200).

In this embodiment, based on reception of the beacon ID (device ID), a service such as notification of a purchase menu is provided to the user. Therefore, it is assumed that the business operator X application, which is a dedicated application having a function of responding to a beacon signal, is installed in the information terminal 100, and that the beacon ID (device ID), which is unique service identification information, is included in the beacon signal. In this embodiment, both iBeacon and Eddystone can be adopted. When the URL type of Eddystone is adopted, the information terminal 100 does not need to have the business operator X application, and only needs to have a chrome browser.

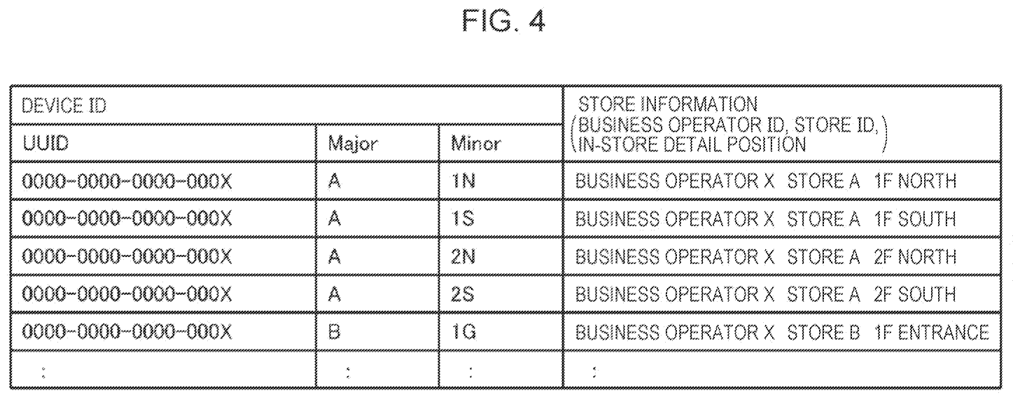

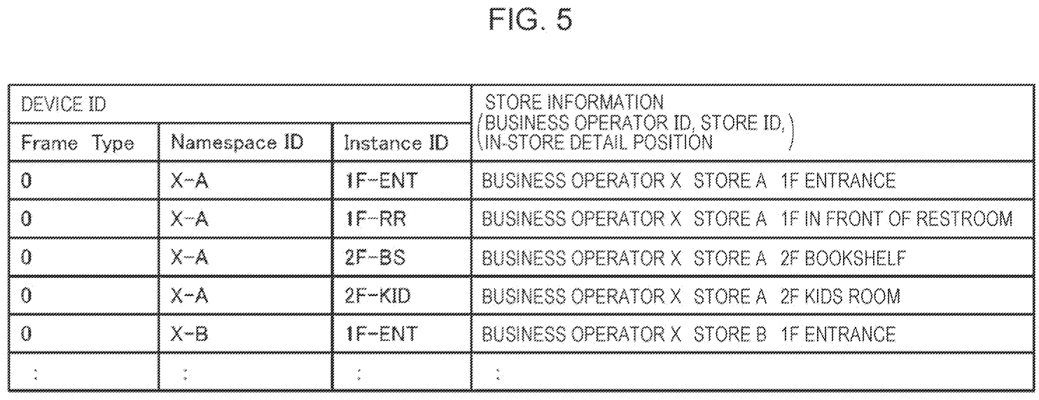

FIGS. 4 and 5 are diagrams illustrating examples of a data configuration of a store dictionary. FIG. 4 is a store directory for a case where iBeacon is adopted, and FIG. 5 is a store directory for a case where the UID type of Eddystone is adopted. In a case of iBeacon, the store dictionary stores the device ID and store information in association with each other. The device ID includes a UUID, a Major value, and a Minor value. The UUID indicates an identifier of the business operator X. The Major value indicates an identifier of a store of the business operator X. The Minor value indicates a detailed position in the store indicated by the Major value. The store information includes a business operator ID, a store ID, and the detailed position in the store.

For example, in the first row, the business operator X, the store A, and the north of the 1F are associated with the UUID “0000-0000-0000-000X”, the Major value “A”, and the Minor value “1N”. Therefore, when the device ID in the first row is included in the received beacon signal, it is understood that the beacon signal is a signal transmitted from the beacon signal transmitter 330 installed in the north of the 1F of the store A of the business operator X. Therefore, it is understood that a user of the information terminal 100 that has received this beacon signal is located in the north of the 1F of the store A of the business operator X.

In a case of the UID type of Eddystone, the device ID includes a frame type, a namespace ID, and an instance ID, and the store information is the same as that in iBeacon. The frame type indicates the type of Eddystone. Here, “0” described in the frame type indicates the UID type. The namespace ID indicates a business operator and a store. The instance ID indicates a detailed position in the store. For example, in the first row, the business operator X, the store A, and the 1F entrance are associated with the frame type “0”, the namespace ID “X-A”, and the instance ID “1F-ENT”. Therefore, it is understood that a user of the information terminal 100 that has received this beacon signal is at the entrance of the 1F of the store A of the business operator X.

The associations between the beacon ID and the store information are examples, and any setting and operation may be performed as long as the association between the beacon ID and the store information can be realized.

Note that the position information of the user may be specified by combining the received beacon ID with a position information detection function provided in the information terminal 100 (for example, position determination by Global Positioning System, region determination by a connected mobile base station, and the like).

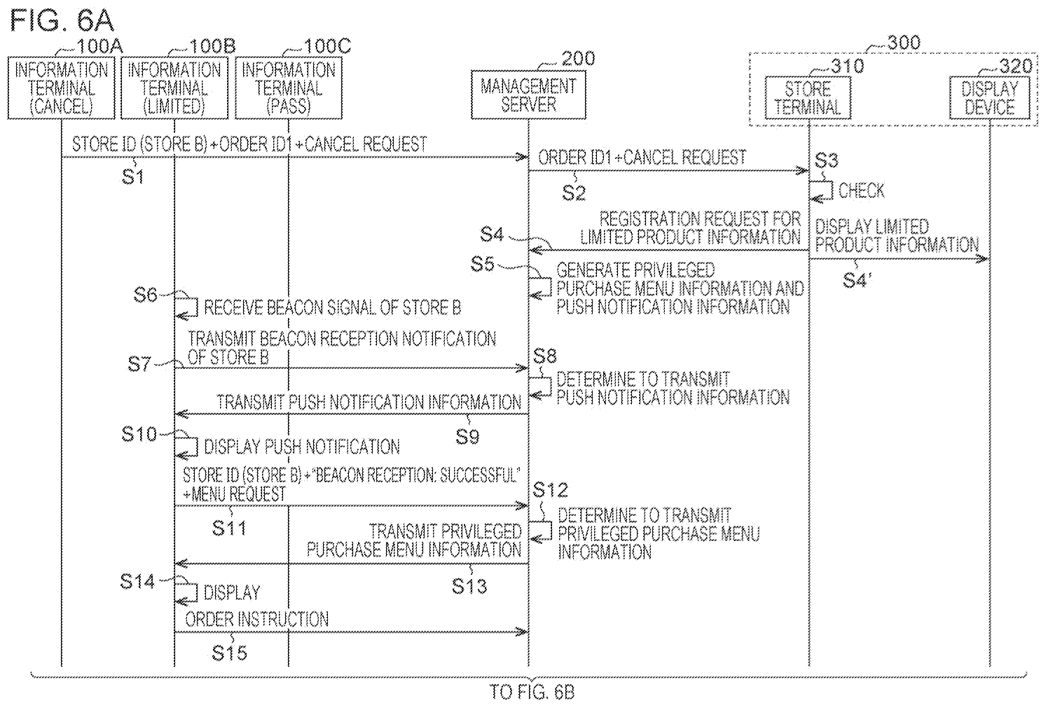

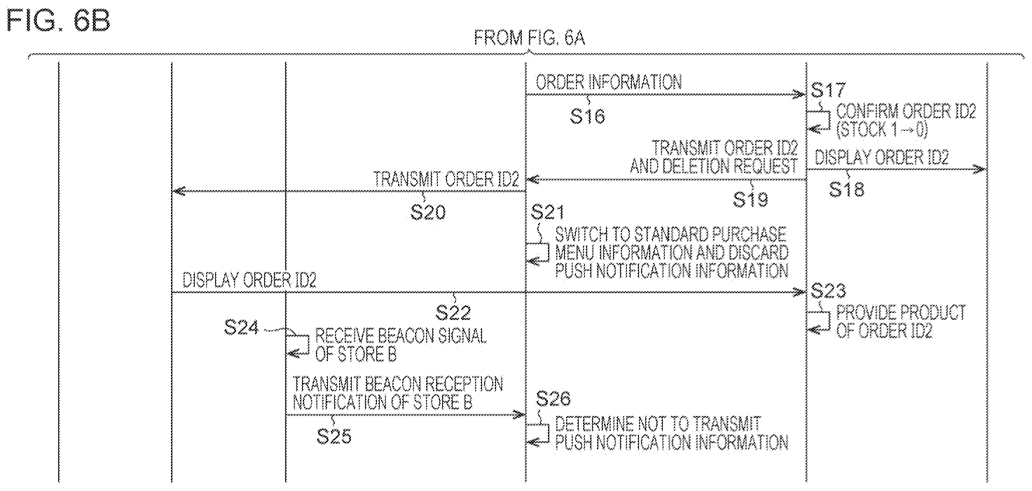

Next, a process performed by the information providing system according to the first embodiment will be described. FIGS. 6A and 6B are a sequence diagram illustrating an example of the process performed by the information providing system according to the first embodiment. In FIGS. 6A and 6B, an information terminal 100A indicates an information terminal 100 that cancels an ordered product. An information terminal 100B indicates an information terminal 100 that receives privileged purchase menu information. An information terminal 100C indicates an information terminal 100 to which push notification information is not transmitted. In FIGS. 6A and 6B, users of the information terminals 100A and 100B order products of the same store. This store may be a store where the users stop by while traveling, for example, on the way home, regardless of the current locations of the users.

The information terminal 100A to which a cancel instruction is input by the user transmits a store ID, an order ID1, and a cancel request to the management server 200 in association with each other (step S1). The store ID is an identifier of a store for which the user has ordered a product. The order ID1 is an identifier of an order, and is an identifier of an order to be canceled this time. In step S1, the user can cancel the order by inputting, for example, a store name and information specifying the order on a cancel screen of the business operator X application.

Subsequently, the management server 200 transmits the received order ID1 and the received cancel request in association with each other to the store terminal 310 of the store indicated by the received store ID (step S2).

Subsequently, the store terminal 310 checks whether the canceled product indicated by the order ID1 can be resold (step S3). In this case, the store terminal 310 presents information on the canceled product to an employee, and when the employee inputs an instruction to permit resale, the store terminal 310 may also check a remaining time during which the canceled product can be resold.

Note that the store terminal 310 may automatically determine whether the canceled product can be resold and, if possible, the remaining time during which the canceled product can be resold.

The management server 200 may automatically determine whether the canceled product can be resold and, if possible, the remaining time during which the canceled product can be resold, and may notify the store terminal 310 of the determination result together with the information on the canceled product.

Having checked that resale is possible, the store terminal 310 determines the canceled product as a limited product, and transmits a registration request for limited product information indicating the limited product to the management server 200 (step S4). As a result, the store terminal 310 registers the limited product information in the store product database, and sets the stock quantity of the limited product (here, it is assumed to be one). Furthermore, having received the registration request for the limited product information, the management server 200 registers the limited product information in the product database of the corresponding store. Subsequently, the store terminal 310 causes the display device 320 to display the limited product information (steps S4′).

In step S5, having received the registration request for the limited product information, the management server 200 generates, based on the limited product information, privileged purchase menu information corresponding to the store that has transmitted the limited product information and push notification information corresponding to the store. The push notification information may include information briefly indicating that the limited product is present in the store.

In this way, by generating the privileged purchase menu information and the push notification information triggered by the reception of the limited product information, it is possible to save time and effort to generate the push notification information each time the beacon reception notification is received, and to save time and effort to generate the privileged purchase menu information each time the menu request is received.

In step S6, the information terminal 100B receives a beacon signal corresponding to a certain store (here, a store B). That is, since the user of the information terminal 100B is in the store B or in the vicinity of the store B, the information terminal 100B receives the beacon signal.

In step S7, the information terminal 100B transmits a beacon reception notification regarding the store B to the management server 200. Note that in step S7, the information terminal 100B may specify the store ID corresponding to the device ID included in the beacon signal using the store dictionary stored in the memory 102, and may transmit a beacon reception notification including the specified store ID to the management server 200.

Subsequently, since the limited product information of the store B is registered through step S4, the management server 200 determines to transmit push notification information to the information terminal 100B (step S8). Here, the privileged purchase menu information includes a product indicated by the limited product information in addition to products indicated by standard purchase menu information of the corresponding store. Thus, it is possible to notify the push notification information only to users who have visited the store B in which the limited product is generated or users in the vicinity of the store, and it is possible to motivate the users to visit the store B.

Subsequently, the management server 200 transmits the push notification information to the information terminal 100B (step S9). Subsequently, the information terminal 100B displays the push notification on the display 105 (step S10). In this way, the information terminal 100B automatically displays the push notification in response to the reception of the beacon signal.

Subsequently, an instruction to select the push notification is input by the user, and thus, the information terminal 100B transmits the store ID of the store B, “beacon reception: successful” indicating that the beacon signal corresponding to the store B has been successfully received, and a menu request to the management server 200 (step S11). Here, the store ID of the store B and “beacon reception: successful” are transmitted because the information terminal 100B has received the beacon signal from the store B in step S6. The store ID, “beacon reception: successful”, and the menu request transmitted in step S11 are examples included in a request for a purchase menu.

Subsequently, having received the store ID, “beacon reception: successful”, and the menu request from the information terminal 100B, the management server 200 determines to transmit the privileged purchase menu information (step S12).

Subsequently, the management server 200 transmits the privileged purchase menu information to the information terminal 100B (step S13). Subsequently, the information terminal 100B displays a privileged purchase menu on the display 105 (step S14). Thus, the user can browse the privileged purchase menu.

Subsequently, the information terminal 100B receives an order instruction for the limited product from the user who has browsed the privileged purchase menu, and transmits order information indicating the order content to the management server 200 (step S15). Subsequently, the management server 200 transmits the order information to the store terminal 310 (step S16).

Subsequently, the store terminal 310 issues an order ID2 of the order for the limited product to confirm the order ID2 (step S17). At this time, the store terminal 310 updates the stock quantity of the limited product. In this example, resale of one limited product is confirmed, and the stock quantity of the limited product becomes zero Subsequently, the store terminal 310 causes the display device 320 to display the order ID2 (step S18). Furthermore, the store terminal 310 transmits the order ID2 to the management server 200, and also transmits a deletion request for the limited product to the management server 200 (step S19). The deletion request for the limited product corresponds to an example of sold-out information. Having received the deletion request, the management server 200 deletes the limited product information registered in the product database of the corresponding store.

Subsequently, the management server 200 transmits the order ID2 to the information terminal 100B (step S20).

Having received the deletion request for the limited product information, the management server 200 switches the setting of the purchase menu of the store B from the privileged purchase menu information to the standard purchase menu information, and also discards the push notification information generated in step S5 or changes the setting to a setting not to transmit the push notification information (step S21).

Subsequently, the information terminal 100B displays the order ID2 (step S22). Subsequently, when an employee who has checked the information terminal 100B on which the order ID2 is displayed completes provision of the limited product to the user, the employee inputs, to the store terminal 310, provision completion information indicating the completion, and the store terminal 310 registers the provision completion information in the store product database (step S23).

In step S24, the information terminal 100C receives a beacon signal corresponding to the store B. That is, since the user of the information terminal 100C is in the store B or in the vicinity of the store B, the information terminal 100C receives the beacon signal.

In step S25, the information terminal 100C transmits a beacon reception notification regarding the store B to the management server 200.

Subsequently, since the setting of the purchase menu information has been switched to the standard purchase menu information in step S21, the management server 200 determines not to transmit the push notification information (step S26).

As described above, in a case where the beacon signal corresponding to the store B is received, if the limited product is sold out in the store B, the push notification is not displayed on the information terminal 100C. In other words, only when the limited product is present in the store B, the push notification of the store B is transmitted to the information terminal 100 of the user in the store B or in the vicinity of the store B. Therefore, the push notification is prevented from being frequently displayed on the information terminal 100C, and the user can be prevented from being bothered.

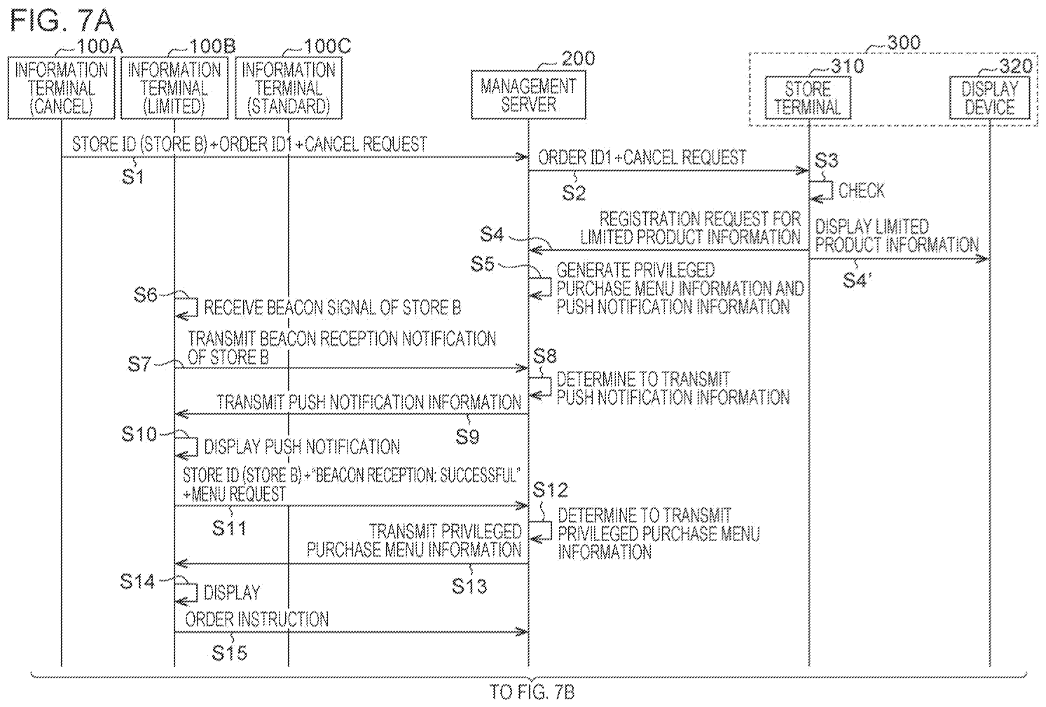

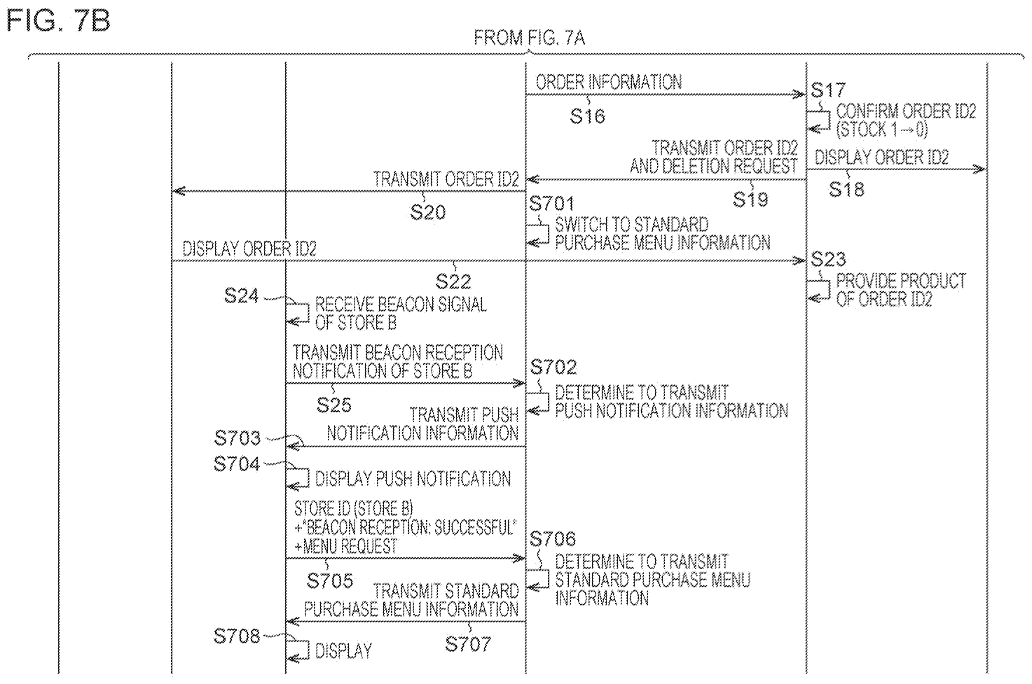

Note that the push notification information transmitted in step S9 may include a unique ID for specifying the privileged purchase menu information corresponding to the push notification information. In this case, in step S11, the information terminal 100B may transmit the unique ID included in the received push notification information to the management server 200 instead of transmitting the store ID, “beacon reception: successful”, and the menu request to the management server 200. Subsequently, having received these pieces of information, the management server 200 may transmit the privileged purchase menu information corresponding to the push notification information corresponding to the unique ID to the information terminal 100B. This also applies to the sequence diagrams in FIGS. 7, 20, and 21 to be described later.

FIGS. 7A and 7B is a sequence diagram illustrating another example of the process performed by the information providing system according to the first embodiment. In the process in FIGS. 6A and 6B, if the limited product is sold out, push notification information is not transmitted to the information terminal 100 (step S26). The process in FIGS. 7A and 7B is different from that in FIGS. 6A and 6B in that push notification information is transmitted to the information terminal 100 even if the limited product is sold out. In FIGS. 7A and 7B, the same processing as that in FIGS. 6A and 6B is denoted by the same step number.

The processing from steps S1 to S20 is the same as that in FIGS. 6A and 6B, and the user inputs an instruction to select the push notification, the privileged purchase menu information is displayed on the information terminal 100B, and the limited product is ordered from the privileged purchase menu. In step S701, since the limited product is sold out, the management server 200 switches the setting of the purchase menu information in the store B to the standard purchase menu information. However, step S701 is different from step S21 in FIG. 6B in that the push notification information is not discarded. The push notification information is not discarded because, in FIGS. 7A and 7B, push notification information that does not include the limited product information is to be transmitted to the information terminal 100 even if the limited product is sold out.

In steps S24 and S25, as in FIG. 6B, the information terminal 100C receives the beacon signal of the store B, and thus, transmits a beacon reception notification.

Note that the information terminal 100C may transmit the beacon reception notification only when a predetermined time (for example, 24 hours) has elapsed for the first time after the last reception of the beacon signal of the store B. Alternatively, the information terminal 100C may transmit the beacon reception notification only when the beacon signal of the store B is received for the first time in a predetermined time slot (for example, during lunch time). Alternatively, these may be combined. By setting the condition for transmitting the beacon reception notification in the above manner, the push notification is prevented from being frequently displayed on the information terminal 100C, and the user can be prevented from being bothered.

Having received the beacon reception notification, in step S702, the management server 200 determines to transmit the push notification information. In step S703, the management server 200 transmits the push notification information to the information terminal 100C. In step S704, the information terminal 100C displays the push notification on the display 105. In step S705, an instruction to select the push notification is input by the user, and thus, the information terminal 100C transmits the store ID of the store B, “beacon reception: successful” indicating that the beacon signal corresponding to the store B has been successfully received, and a menu request to the management server 200.

Having received the store ID of the store B, “beacon reception: successful”, and the menu request, since the setting of the purchase menu information of the store B has been switched to the standard purchase menu information in step S701, the management server 200 determines to transmit the standard purchase menu information (step S706).

Subsequently, the management server 200 transmits the standard purchase menu information to the information terminal 100C (step S707). Subsequently, the information terminal 100C displays the standard purchase menu on the display 105 (step S708). When the user who has browsed the standard purchase menu inputs an order instruction for the product to the information terminal 100C, the processing in steps S15 to S20, S21, and S23 is similarly performed, and the product is provided to the user.

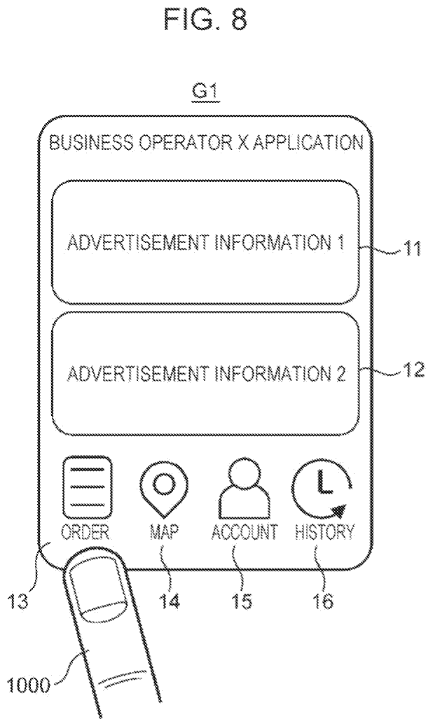

FIG. 8 is a diagram illustrating an example of an initial screen G1 of the business operator X application. The initial screen G1 is displayed on the display 105 when a user inputs an instruction to start the business operator X application to the information terminal 100. The initial screen G1 includes an advertisement display field 11 and an advertisement display field 12 displayed at the center. In each of the advertisement display field 11 and the advertisement display field 12, an advertisement of a recommended product, service, or the like of the business operator X is displayed. The number of advertisement display fields may be one, or three or more.

In a lower part of the initial screen G1, an order button 13, a map button 14, an account button 15, and a history button 16 are provided. The order button 13 is a button to be selected when a product or the like is ordered from the business operator X application. Hereinafter, the selection operation is referred to as “touch”. The map button 14 is a button to be touched in order to check stores of the business operator X on a map around the current location. The account button 15 is a button to be touched when registering, checking, or updating a user account. The history button 16 is a button to be touched when referring to the user's past order history.

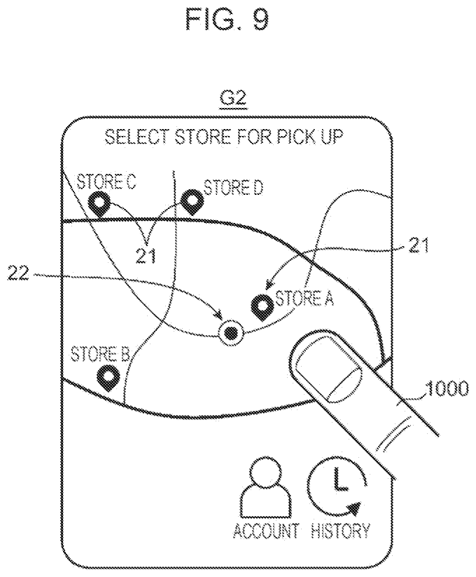

FIG. 9 is a diagram illustrating an example of a map screen G2. The map screen G2 is displayed when the map button 14 is touched on the initial screen G1. A map around the current location of the user is displayed on the map screen G2. On the map screen G2, a current location icon 22 indicating the current location of the user is displayed. On the map screen G2, store icons 21 indicating stores around the current location are displayed. Here, four store icons 21 of stores A, B, C, and D are displayed, and the user can check that there are four stores belonging to the business operator X around the current location. The user browses the map screen G2 and selects a store to order a product. In this example, the user touches the store icon 21 of the store A with an indicator 1000 to select the store A. The indicator 1000 is, for example, a finger of the user. Upon the store icon 21 of the store A being touched, for example, the information terminal 100 acquires standard purchase menu information of the store A from the management server 200, and displays the standard purchase menu on the display 105.

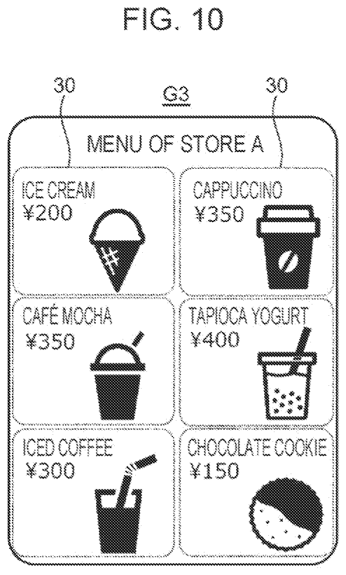

FIG. 10 is a screen diagram illustrating an example of a standard purchase menu G3. The standard purchase menu G3 displays products that the user can order in the store A that the user selects. Here, since the store A is a fast-food store, the products that the user can order are food and drink. “Menu of Store A” is displayed in an upper part of the standard purchase menu G3 to indicate that the standard purchase menu G3 belongs to the store A. In the standard purchase menu G3, tile objects 30 corresponding to a plurality of orderable products are displayed. Each of the tile objects 30 has a rectangular outer frame, and displays a product name, a price of the product, and an image indicating the product. Here, since the store A provides food and drink, the tile objects 30 corresponding to the respective food and drink such as ice cream and cappuccino are displayed.

Although the tile objects 30 here are arranged in three rows x two columns, this is an example. In addition, the tile objects 30 have the same size. When a scroll operation is input on the standard purchase menu G3, the information terminal 100 scrolls the standard purchase menu G3 and displays tile objects 30 that have not been displayed on the display 105. Thus, the user can cause the display 105 to display tile objects 30 of products hidden on the initial screen of the standard purchase menu G3, and can order any of the products.

The standard purchase menu information includes layout information for specifying display positions of the tile objects 30 on the standard purchase menu G3, a priority order of the products, image data of the tile objects 30, and the like. Therefore, the information terminal 100 may draw the standard purchase menu G3 by arranging the tile objects 30 corresponding to the products in descending order of priorities in accordance with the layout information. The priority order of the products is defined in advance in the store A. For example, the order may be such that a more popular product has a higher priority. Here, the standard purchase menu G3 may be different for each store or may be a purchase menu common to all stores of the business operator X.

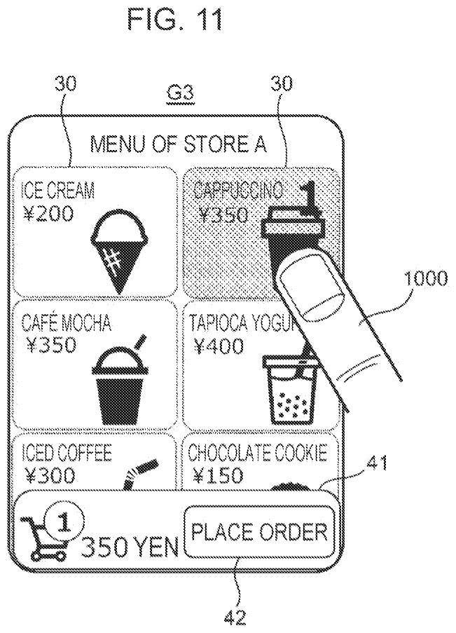

FIG. 11 is a diagram illustrating the standard purchase menu G3 in which an order field 41 is superimposed and displayed. When the user touches a tile object 30 of a desired product with the indicator 1000, the information terminal 100 superimposes and displays the order field 41 in a lower part of the standard purchase menu G3.

The order field 41 includes the number of ordered products, the price of the ordered product, and an order button 42. Here, the tile object 30 of a cappuccino is touched by the indicator 1000. Therefore, “1” indicating the number of ordered cappuccinos and the price of the cappuccino are displayed in the order field 41. Note that the user can order a plurality of same products by touching the same tile object 30 a plurality of times. The user can also select a plurality of products of different types by touching a plurality of different tile objects 30. Having completed the order operation, the user touches the order button 42. Upon the order button 42 being touched, the information terminal 100 transmits order information including the type and the number of ordered products to the management server 200. Thus, the order is received.

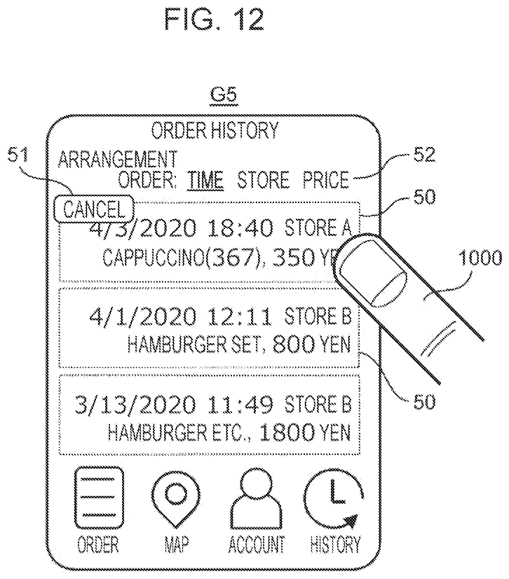

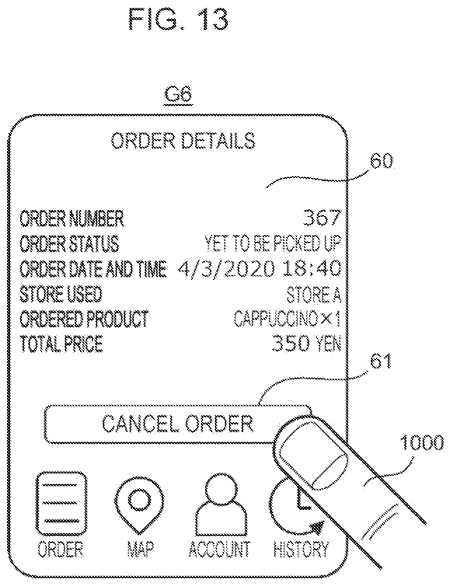

FIG. 12 is a diagram illustrating an example of an order history screen G5. FIG. 13 is a diagram illustrating an example of an order detail screen G6. The order history screen G5 is displayed upon the history button 16 being touched on the initial screen G1. The order history screen G5 is a screen displaying, as a list, the order history of products ordered by the user in the past using the business operator X application. The order history screen G5 includes order history fields 50 corresponding to the respective past orders.

An arrangement order change field 52 for changing the arrangement order of the order history fields 50 is provided in an upper part of the order history screen G5. In the arrangement order change field 52, “time”, “store”, and “price” are displayed. When “time” is touched, the order history fields 50 are rearranged in order from the most recent order time. When “store” is touched, the order history fields 50 are rearranged according to the store designated for pick up. When “price” is touched, the order history fields 50 are rearranged in descending order or ascending order of the ordered price. The order history screen G5 is configured to be scrollable. Therefore, by scrolling the order history screen G5, the user can cause order history fields 50 that have not been displayed on the initial screen of the order history screen G5 to be displayed, and can check the past order history.

In each of the order history fields 50, an order date, an order time, an order store, a product name of an ordered product, and a total price of ordered products are displayed. For example, in the order history field 50 in the first row, a past order for the store A at 18:40 on Apr. 3, 2020 is displayed. Here, since a cappuccino has been ordered, “cappuccino”, which is a product name, and “350 yen”, which is the price of the cappuccino, are displayed in the order history field 50. The numeral (367) in parentheses after the product name “cappuccino” is an order number. The order number is displayed only when a product is yet to be picked up. A cancel button 51 is displayed at the left end of the order history field 50 indicating an order for a product that is yet to be picked up. The cancel button 51 is touched to cancel an ordered product.

Upon the cancel button 51 being touched, the information terminal 100 displays the order detail screen G6 on the display 105. The order detail screen G6 is a screen that displays details of the past order indicated by the order history field 50 for which the cancel button 51 is touched.

The order detail screen G6 includes an order content field 60 and an order cancel button 61. In the order content field 60, an order number, an order status, an order date and time, a store used, an ordered product, and a total price are displayed. The order status indicates a state of the ordered product. The state includes “waiting to be picked up” in which the product is yet to be picked up, “picked up” in which the product is picked up, and the like. When the user browses the order detail screen G6 and determines cancellation, the user touches the order cancel button 61. Upon the order cancel button 61 being touched, the information terminal 100 transmits the store ID (the ID of the store A), the order ID (367), and a cancel request in association with each other to the management server 200. This processing corresponds to step S1 in FIG. 6A. Thus, a limited product is generated.

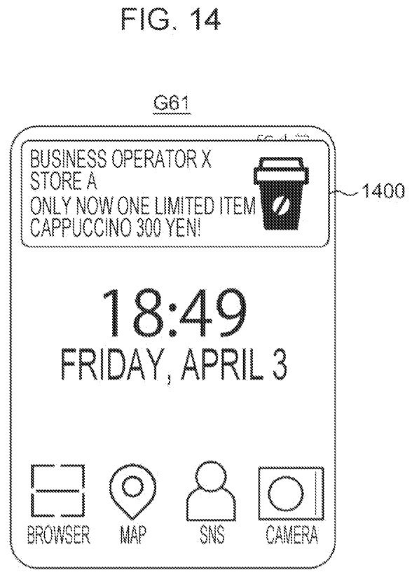

FIG. 14 is a diagram illustrating an example of a display screen G61 on which a push notification 1400 is displayed. Here, the push notification 1400 of the store A is displayed. Here, the push notification 1400 of the store A is displayed because the user is located in or near the store A at a timing when the user can purchase the limited product in the store A. Specifically, since the information terminal 100 that has received a beacon signal of the store A has transmitted a beacon reception notification of the store A to the management server 200, push notification information is transmitted to the information terminal 100 and the push notification 1400 is displayed. This processing corresponds to step S10 in FIG. 6A.

In the push notification 1400, information briefly indicating the limited product in the store A is displayed. Specifically, in the push notification 1400, the name of the store A, “cappuccino” indicating the name of the limited product, “300 yen” indicating the price of the limited product, “only now one item limited” indicating the stock quantity of the limited product, and an image of the limited product are displayed. However, the content displayed in the push notification 1400 is merely an example, and any of pieces of the information illustrated in FIG. 14 may be omitted. For example, more simplified information may also be displayed in the push notification 1400, such as including only a message indicating that there is a notification from the store A. In a case where the mode described with reference to FIGS. 7A and 7B (the mode in which the push notification information is transmitted even if the limited product is sold out) is adopted, if the user is in or near the store A after the limited product is sold out, the push notification 1400 that does not include the content related to the limited product is preferably displayed.

When the push notification 1400 is touched by the user, the information terminal 100 transmits information indicating that the push notification is selected to the management server 200. Thus, the information terminal 100 receives privileged purchase menu information from the management server 200, and displays the privileged purchase menu on the display 105.

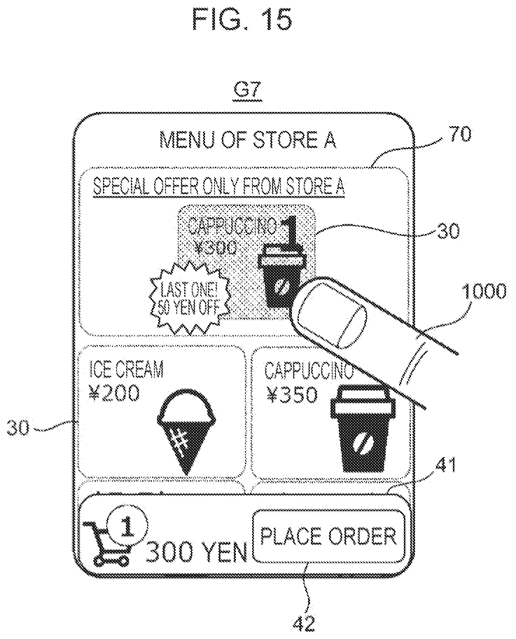

FIG. 15 is a screen diagram illustrating an example of a privileged purchase menu G7. The privileged purchase menu G7 is displayed when the user is near the store A at a timing when the user can order the limited product in the store A and when the user touches the push notification 1400. That is, at a timing immediately before the user displays the purchase menu of the store A, the information terminal 100 of the user detects a beacon signal corresponding to the store A and displays, on the display 105, the push notification 1400 transmitted from the management server 200 in response to the detection. When the user touches the push notification 1400, the information terminal 100 transmits the store ID of the store A, “beacon reception: successful”, and the menu request in association with each other to the management server 200. Thus, the information terminal 100 receives the privileged purchase menu information, and displays the privileged purchase menu G7 on the display 105. This processing corresponds to steps S6 to S10 in FIG. 6A.

Unlike in the standard purchase menu G3 illustrated in FIG. 10, a limited product field 70 indicating the current limited product of the store A is arranged in an upper part of the privileged purchase menu G7. Thus, it is possible to appeal the presence of the limited product to the user in an easy-to-understand manner.

The width of the limited product field 70 is approximately twice the width of the tile object 30. A tile object 30 indicating the limited product is arranged in the limited product field 70. Here, since a cappuccino is generated as the limited product, the tile object 30 indicating a cappuccino is arranged in the limited product field 70. In the tile object 30, in addition to the product name and the price, a message (last one! 50 yen off) indicating the stock quantity and the discount amount is displayed. Thus, the user can understand that there is only one limited product left and the limited product can be purchased at a price of 50 yen lower than the normal price. Although the discount amount is displayed here, a discount rate (for example, 20% OFF) or the like may be displayed.

A message stating “special offer only from store A” is further displayed in the limited product field 70. This message can make the user recognize that the cappuccino is the limited product of the store A.

On the privileged purchase menu G7, the standard purchase menu is displayed below the limited product field 70. In the standard purchase menu, as in the standard purchase menu G3 illustrated in FIG. 10, the tile objects 30 are arranged according to the priority order of the products.

As in the standard purchase menu G3, the privileged purchase menu G7 is configured to be scrollable. Therefore, by performing a scroll operation, the user can cause tile objects 30 that have not been displayed on the initial screen of the privileged purchase menu G7 to be displayed, and can order a low-priority product.

When there are a plurality of limited products, a plurality of limited product fields 70 are displayed on the privileged purchase menu G7. In this case, the information terminal 100 may display the plurality of limited product fields 70 in order from the top on the privileged purchase menu G7.

Note that the present disclosure is not limited to this, and even when there are a plurality of limited products, the plurality of limited products may be displayed in the limited product field 70 by changing (enlarging) the size of the limited product field 70.

The privileged purchase menu information transmitted from the management server 200 includes layout information indicating display positions of the limited product field 70, the tile objects 30, and the like, information for specifying the limited product, the priority order of the products, image data of the tile objects 30 corresponding to the products, and the like. Therefore, the information terminal 100 may draw the privileged purchase menu G7 on the display 105 by arranging the limited product field 70 and the tile objects 30 in accordance with the layout information.

When the user touches one of the tile objects 30 with the indicator 1000 on the privileged purchase menu G7, the information terminal 100 superimposes and displays the order field 41 in a lower part of the privileged purchase menu G7. Here, since the tile object 30 of the cappuccino, which is the limited product, is touched, the number of ordered cappuccinos, the price, and the order button 42 are displayed in the order field 41.

Having completed the order operation, the user touches the order button 42. Upon the order button 42 being touched, the information terminal 100 transmits order information including the type and the number of ordered products to the management server 200. Thus, the order is received. This processing corresponds to step S15 in FIG. 6A.

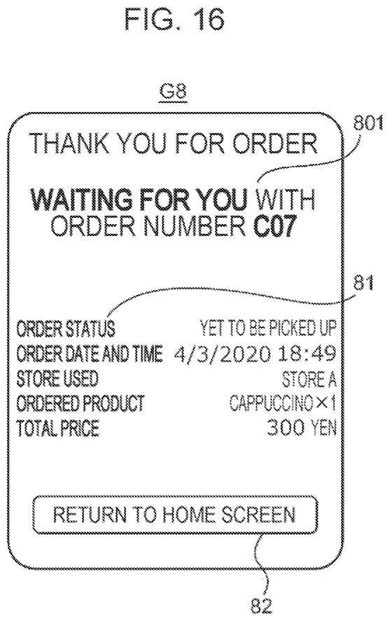

FIG. 16 is a diagram illustrating an order confirmation screen G8 displayed on the information terminal 100. FIG. 17 and FIG. 18 are diagrams illustrating examples of an order status screen G9 displayed on the display device 320.

Upon the order button 42 being touched on the privileged purchase menu G7, the information terminal 100 displays the order confirmation screen G8. An order number field 801 for displaying the order number (order ID), an order content field 81, and a return button 82 are displayed on the order confirmation screen G8.

The order ID is displayed in the order number field 801. The order ID is issued by the store terminal 310 of the store A that has received the order, and is an identifier for identifying the order.

The order status, the order date and time, the store used, the ordered product, and the total price are displayed in the order content field 81. Details of these are the same as those in the order content field 60. The return button 82 is a button for returning to the initial screen G1 (home screen).

The order status screen G9 is a screen for notifying the order status to users who visit the store A. The order status screen G9 in FIG. 17 illustrates a case where there is a limited product, whereas the order status screen G9 in FIG. 18 illustrates a case where there is no limited product.

Display fields 91, 92, and 93 are displayed on the order status screen G9. The display field 91 is a field for displaying order IDs of products that have been cooked and are ready to be picked up by users. The display field 92 is a field for displaying order IDs of products that are being cooked. The display field 93 is a field for displaying limited product information. Here, since a cappuccino is generated as the limited product, limited product information about the cappuccino is displayed in the display field 93. Specifically, the product name, price, image, and discount amount of the cappuccino are displayed in the display field 93. Thus, users who visit the store A can check the limited product. A user who desires to order the limited product starts the business operator X application, selects the store A from the map screen G2, causes the display 105 to display the privileged purchase menu G7, and orders the cappuccino. Alternatively, the user who desires to order the limited product may start the business operator X application, the business operator X application may specify the store A from the received beacon signal, and the user may touch the order button 13 to cause the display 105 to display the privileged purchase menu G7, and may order the cappuccino. Alternatively, instead of using the business operator X application, the user may tell an employee at a store counter that they desire to purchase the cappuccino. Note that the processing of displaying the order status screen G9 in FIG. 18 corresponds to step S4′ in FIG. 6B. Upon completion of the order for the cappuccino, the order confirmation screen G8 is displayed on the display 105.

In this case, since the order for the limited product has been received, the order ID “C07” for the limited product is added to the display field 91 of the order status screen G9 in FIG. 18. Since the stock quantity of the limited product becomes zero his order, the limited product information is deleted from the display field 93 of the order status screen G9 in FIG. 18.

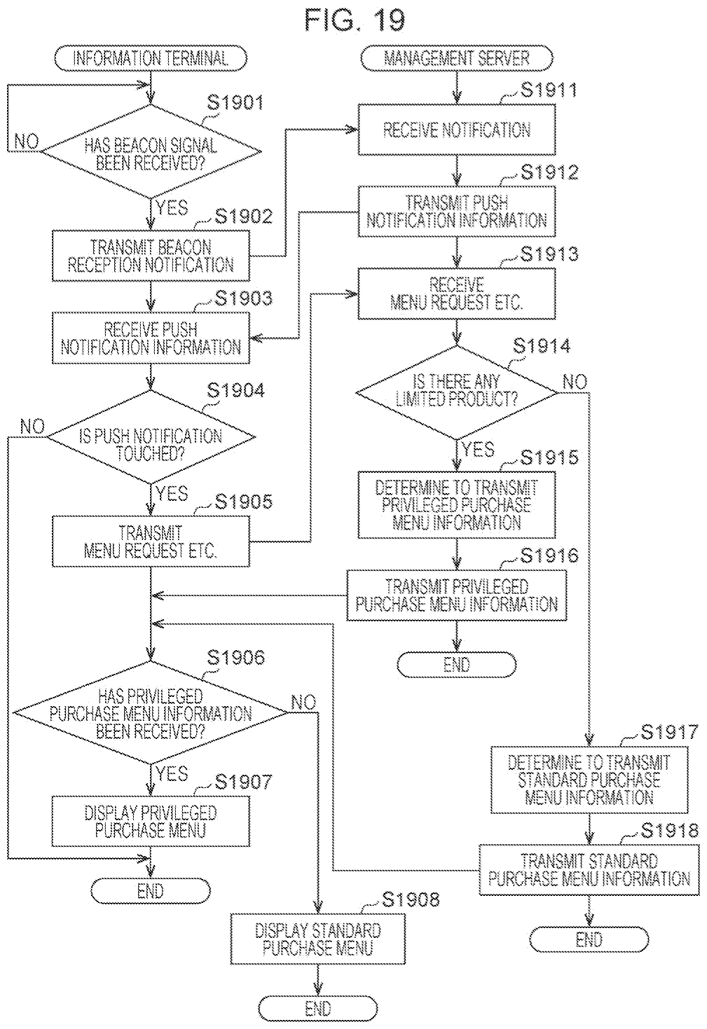

Next, the process performed by the information providing system according to the first embodiment will be described in detail. FIG. 19 is a flowchart illustrating details of the process performed by the information providing system according to the first embodiment. Note that this flowchart illustrates details of the process performed by the information providing system for a case where the mode described in FIGS. 7A and 7B is adopted, the mode displaying the push notification 1400 regardless of the presence or absence of the limited product.

First, the calculation unit 104 of the information terminal 100 determines whether the short-range communication unit 103 has successfully received a beacon signal (step S1901). This processing corresponds to step S6 in FIG. 6A. If the beacon signal has been successfully received (YES in step S1901), the process proceeds to step S1902. Here, it is assumed that the beacon signal of the store B is received. On the other hand, if the reception of the beacon signal has been failed (NO in step S1901), the process returns to step S1901.

Subsequently, the communication unit 101 of the information terminal 100 transmits a beacon reception notification to the management server 200 (step S1902).

In step S1911, the communication unit 201 of the management server 200 receives the notification. Subsequently, the communication unit 201 of the management server 200 transmits push notification information to the information terminal 100 (step S1912).

Subsequently, the communication unit 101 of the information terminal 100 receives the push notification information (step S1903). Accordingly, the display 105 displays the push notification 1400. Subsequently, the operation unit 106 of the information terminal 100 determines whether the push notification 1400 is touched (step S1904). If the push notification 1400 is touched (YES in step S1904), the communication unit 101 transmits a menu request and the like to the management server 200 (step S1905). The menu request and the like transmitted here may include the store ID of the store B, “beacon reception: successful”, and the menu request. Alternatively, the communication unit 101 may transmit the unique ID corresponding to the push notification 1400 to the management server 200. The store ID of the store B is transmitted because the calculation unit 104 determines that the device ID included in the beacon signal received in step S1902 corresponds to the store ID of the store B by referring to the store dictionary.

On the other hand, if the push notification 1400 is not touched (NO in step S1904), the process ends.

In step S1913, the communication unit 201 of the management server 200 receives the menu request and the like. Subsequently, the calculation unit 202 of the management server 200 determines whether there is any limited product in the store B (step S1914). Here, if limited product information is registered in the product database of the store B stored in the memory 203, the calculation unit 202 may determine that there is a limited product in the store B. If limited product information is not registered in the product database of the store B, the calculation unit 202 may determine that there is no limited product in the store B.

If it is determined in step S1914 that there is a limited product in the store B (YES in step S1914), the process proceeds to step S1915. If it is determined in step S1914 that there is no limited product in the store B (NO in step S1914), the process proceeds to step S1917.

In step S1915, the calculation unit 202 determines to transmit privileged purchase menu information in which the limited product indicated by the limited product information is added to standard purchase menu information of the store B.

Subsequently, the calculation unit 202 transmits identification information indicating that the information is the privileged purchase menu information, and the privileged purchase menu information of the store B to the information terminal 100 via the communication unit 201 (step S1916). In step S1917, the calculation unit 202 determines to transmit the standard purchase menu information of the store B. Subsequently, in step S1918, the calculation unit 202 transmits the standard purchase menu information corresponding to the store B to the information terminal 100 via the communication unit 201.

In step S1906, the calculation unit 104 of the information terminal 100 determines whether the privileged purchase menu information has been received. If the privileged purchase menu information has been received (YES in step S1906), the calculation unit 104 displays the privileged purchase menu on the display 105 (step S1907). On the other hand, if the standard purchase menu information has been received (NO in step S1906), the calculation unit 104 displays the standard purchase menu on the display 105 (step S1908).

If the management server 200 not only transmits the purchase menu information but also determines and transmits the display design thereof to the information terminal 100, the information terminal 100 may display the purchase menu on the display 105 in accordance with the display design of the purchase menu information received from the management server 200. In this case, the privileged purchase menu information transmitted in step S1916 or the standard purchase menu information transmitted in step S1918 may be directly displayed on the display 105 of the information terminal 100 in accordance with the designated design without performing the determination in step S1906. This can be easily realized by using Hypertext Markup Language (HTML), for example.

As described above, according to this embodiment, the limited product information indicating the limited product for which the time available for sale is limited is acquired, the push notification is displayed to a person who is within the reception range of the beacon signal from the store, and, in response to the menu request based on the push notification, the privileged purchase menu including the limited product is displayed. Thus, it is possible to timely provide information about the limited product, which changes from moment to moment depending on stock or time, to a person in the store or in the vicinity of the store through the information terminal 100. As a result, food waste can be reduced.

Furthermore, according to this embodiment, the purchase menu information is generated in response to the menu request based on the push notification and is output to the information terminal 100. Therefore, the purchase menu is prevented from being displayed on the information terminal 100 against the will of the user, and the user can be prevented from being bothered.

### Second Embodiment

Next, a second embodiment will be described. In the second embodiment, an advertisement of a store is displayed on the information terminal 100 instead of the purchase menu. In this embodiment, the same components as those in the first embodiment are denoted by the same reference numerals, and description thereof will be omitted. Also, block diagrams and screen diagrams in this embodiment are the same as those in the first embodiment.

FIG. 1 is to be referred to. In this embodiment, the business operator X is a business operator who develops a chain of retail stores such as supermarkets. Therefore, the store A and the store B are stores belonging to the supermarket chain developed by the business operator X. The business managed by the business operator X is not limited to supermarkets, and may be a business for manufacturing and selling packed meals, a ready-made meal business for manufacturing and selling delicatessen, or a fast-food business. Products that the stores sell in this embodiment may include, for example, perishable foods such as vegetables, fruits, seafood, and meats, beverages such as coffees, fruit juices, and teas, hamburgers, Sushi, packed meals, and delicatessen, and the like.

FIG. 2 is to be referred to. In this embodiment, the display 105 displays an advertisement of a store. In this embodiment, the operation unit 106 receives an instruction to select a push notification. In this embodiment, the communication unit 201 transmits advertisement information for causing the information terminal 100 to display the advertisement. The advertisement information may include, for example, layout information for specifying a display position or the like of a graphical user interface (GUI) component constituting the advertisement and various image data of the GUI component. As described later, there are two types of advertisement information, which are privileged advertisement information and standard advertisement information.

In this embodiment, upon reception of a store ID of a store corresponding to the push notification, “beacon reception: successful”, and an advertisement request, or the unique ID corresponding to the push notification 1400, from the information terminal 100 via the communication unit 201, the calculation unit 202 determines to transmit privileged advertisement information in which a limited product indicated by limited product information is added to a standard advertisement of the store indicated by the store ID, and transmits the privileged advertisement information to the information terminal 100 via the communication unit 201.

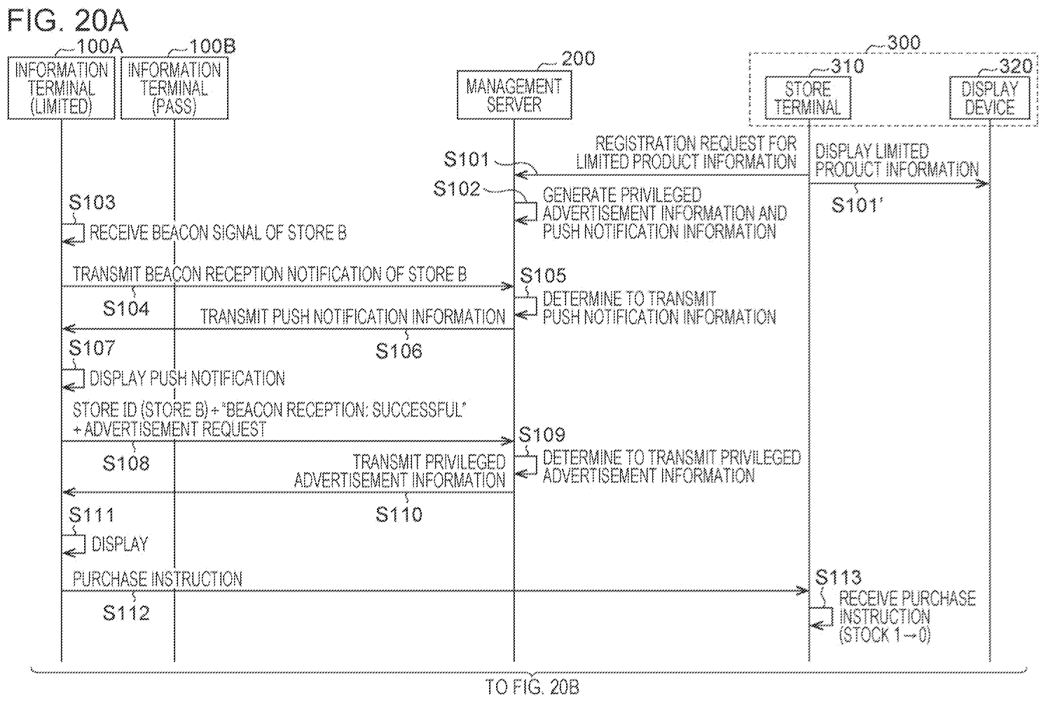

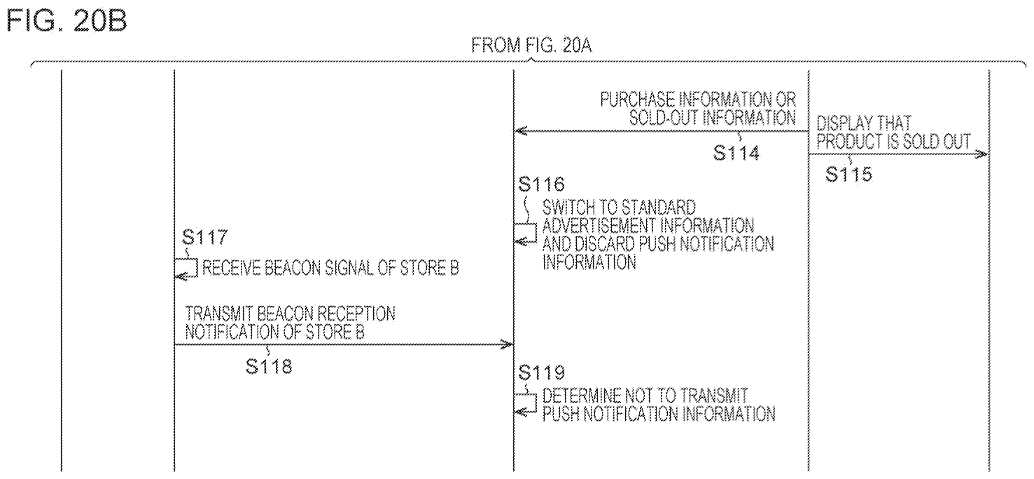

FIGS. 20A and 20B are a sequence diagram illustrating an example of a process performed by an information providing system according to the second embodiment. In FIGS. 20A and 20B, the information terminal 100A indicates an information terminal 100 that receives privileged advertisement information (advertisement information including limited product information in addition to standard advertisement information). The information terminal 100B indicates an information terminal 100 to which push notification information is not transmitted.

First, upon reception of an instruction to display a limited product from an employee of a store or detection that a certain product satisfies a condition for being handled as a limited product, the store terminals 310 transmits a registration request for limited product information indicating the limited product to a management server 200 (step S101). As a result, the store terminal 310 registers the limited product information in the store product database, and sets the stock quantity of the limited product. Furthermore, having received the registration request for the limited product information, the management server 200 registers the limited product information in the product database of the corresponding store. Subsequently, the store terminal 310 causes the display device 320 to display the limited product information (steps S101′).

In step S102, having received the registration request for the limited product information, the management server 200 generates, based on the limited product information, privileged advertisement information corresponding to the store that has transmitted the limited product information and push notification information corresponding to the store. The push notification information may include information briefly indicating that the limited product is present in the store.

In this way, by generating the privileged advertisement information and the push notification information triggered by the reception of the limited product information, it is possible to save time and effort to generate the push notification information each time the beacon reception notification is received, and to save time and effort to generate the privileged purchase advertisement information each time the advertisement request is received.

Steps S103 to S107 are the same as steps S6 to S10 in FIG. 6A, and the beacon signal corresponding to the store B is received by the information terminal 100A, and the push notification is displayed on the display of the information terminal 100A.

In step S108, an instruction to select the push notification is input by the user, and thus, the information terminal 100A transmits the store ID of the store B, “beacon reception: successful” indicating that the beacon signal corresponding to the store B has been successfully received, and an advertisement request, or the unique ID corresponding to the push notification, to the management server 200. The store ID, “beacon reception: successful”, and the advertisement request transmitted in step S108 are examples included in a request for an advertisement.

Subsequently, having received the store ID, “beacon reception: successful”, and the menu request, or the unique ID corresponding to the push notification, from the information terminal 100B, the management server 200 determines to transmit the privileged advertisement information (step S109).

Subsequently, the management server 200 transmits the privileged advertisement information to the information terminal 100A (step S110). Subsequently, the information terminal 100A displays a privileged advertisement on the display 105 (step S111). Thus, the user can browse the privileged advertisement.

Subsequently, the user uses the information terminal 100A to present an instruction to purchase the limited product to the store terminal 310 (step S112). In this case, the user who has browsed the privileged advertisement may cause the information terminal 100 to display an initial screen G100, which will be described later, at a cash register of a store where the user purchases a product, and may present the initial screen G100 to have a store clerk read it with the store terminal 310 or may directly have the store terminal 310 read it by themself to present a purchase instruction.

Subsequently, the store terminal 310 receives the purchase instruction (step S113). Here, if the limited product is included in the product to be purchased, the stock quantity of the limited product is subtracted by the number thereof to be sold. Here, it is assumed that the number of limited products to be sold is one, and as a result, the stock quantity is changed from one to zero.

Having received the purchase instruction, the store terminal 310 reads authentication information included in the initial screen G100 described later to determine whether to sell the limited product at a special price, and if it is determined to sell the limited product at the special price, may settle the limited product at the special price. The special price is a price discounted from a standard price.

The authentication information includes information indicating whether the user is a user who is allowed to purchase the limited product at the special price. For example, only when the privileged advertisement information is received, the information terminal 100 may cause the authentication information to include information indicating that the user is allowed to purchase the limited product at the special price. Thus, the limited product can be sold at the special price only to the user who has browsed the privileged advertisement. As the authentication information, for example, a barcode or a quick response (QR) code (registered trademark) can be adopted. The store terminal 310 may read the authentication information with a barcode reader, a QR code reader, or the like. Alternatively, the store terminal 310 may read the authentication information from the information terminal 100 by near-field communication (NFC) or the like which is short-range wireless communication.

Subsequently, the store terminal 310 causes the display device 320 to display information indicating that the limited product is sold out or refrains from displaying the limited product information (step S115). Furthermore, the store terminal 310 transmits sold-out information indicating that the limited product is sold out to the management server 200 (step S114). Having received the sold-out information, the management server 200 deletes the limited product information registered in the product database of the corresponding store. In a case where the limited product is not sold out, the store terminal 310 may transmit purchase information including the number of limited products to be sold and/or the stock quantity thereof to the management server 200 instead of the sold-out information. Having received the purchase information, the management server 200 may subtract the stock quantity of the limited product registered in the product database of the corresponding store by the number thereof to be sold.

Having received the sold-out information, the management server 200 switches the setting of the advertisement of the corresponding store from the privileged advertisement information to the standard advertisement information, and also discards the push notification information generated in step S102 or changes the setting to a setting not to transmit the push notification information (step S116).

Steps S117 to S119 are the same as steps S24 to S26 in FIG. 6B. Although the beacon signal of the store B is received by the information terminal 100C, since the limited product is sold out, the push notification information is not transmitted to the information terminal 100C.

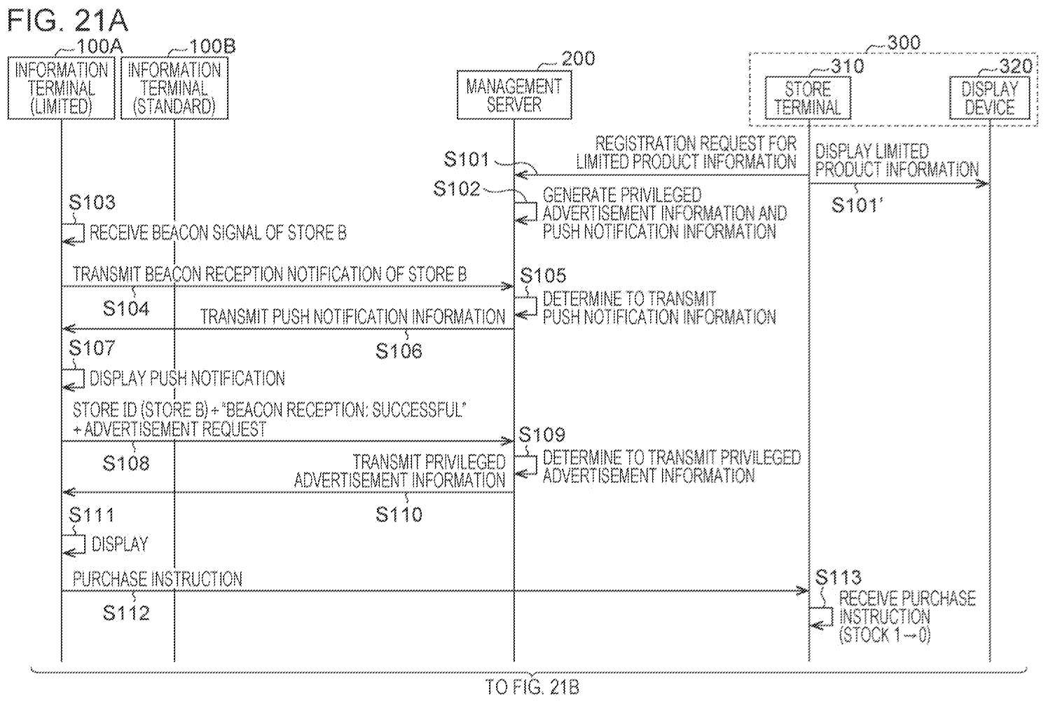

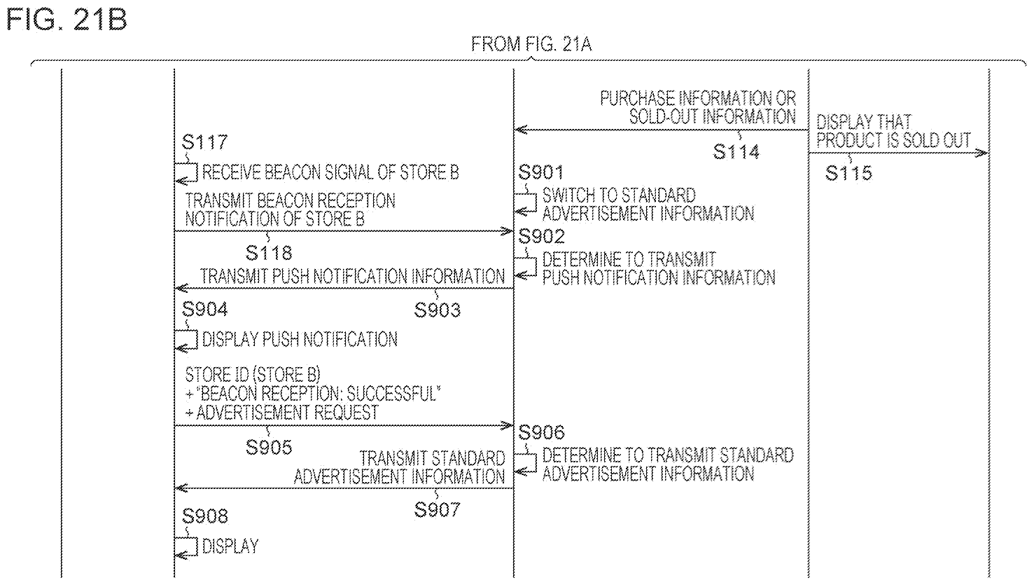

FIGS. 21A and 21B are a sequence diagram illustrating another example of the process performed by the information providing system according to the second embodiment. In the process in FIGS. 20A and 20B, if the limited product is sold out, push notification information is not transmitted to the information terminal 100 (step S119). The process in FIGS. 21A and 21B is different from that in FIGS. 20A and 20B in that push notification information is transmitted to the information terminal 100 even if the limited product is sold out. In FIGS. 21A and 21B, the same processing as that in FIGS. 20A and 20B is denoted by the same step number.

The processing from steps S101 to S115 is the same as that in FIGS. 20A and 20B, and the user inputs an instruction to select the push notification, the privileged advertisement is displayed on the information terminal 100A. In step S901, since the limited product is sold out, the management server 200 switches the setting of the advertisement information in the store B to the standard advertisement information. However, the step S901 is different from the step S116 in FIG. 20B in that the push notification information is not discarded, that is, the push notification information continues to be transmitted, even if the limited product is not present in the store. The push notification information is not discarded because, in FIGS. 21A and 21B, push notification information is to be transmitted to the information terminal 100 even if the limited product is sold out.

In steps S117 and S118, as in FIG. 20B, the information terminal 100B receives the beacon signal of the store B, and thus, transmits a beacon reception notification.

Having received the beacon reception notification, in step S902, the management server 200 determines to transmit the push notification information. In step S903, the management server 200 transmits the push notification information to the information terminal 100B. In step S904, the information terminal 100B displays the push notification on the display 105. In step S905, an instruction to select the push notification is input by the user, and thus, the information terminal 100B transmits the store ID of the store B, “beacon reception: successful” indicating that the beacon signal corresponding to the store B has been successfully received, and an advertisement request, or the unique ID corresponding to the push notification, to the management server 200.

Having received the store ID of the store B, “beacon reception: successful”, and the advertisement request, or the unique ID corresponding to the push notification, since the setting of the advertisement information of the store B has been switched to the standard advertisement information in step S901, the management server 200 determines to transmit the standard advertisement information (step S906).

Subsequently, the management server 200 transmits the standard advertisement information to the information terminal 100B (step S907). Subsequently, the information terminal 100B displays the standard advertisement on the display 105 (step S908).

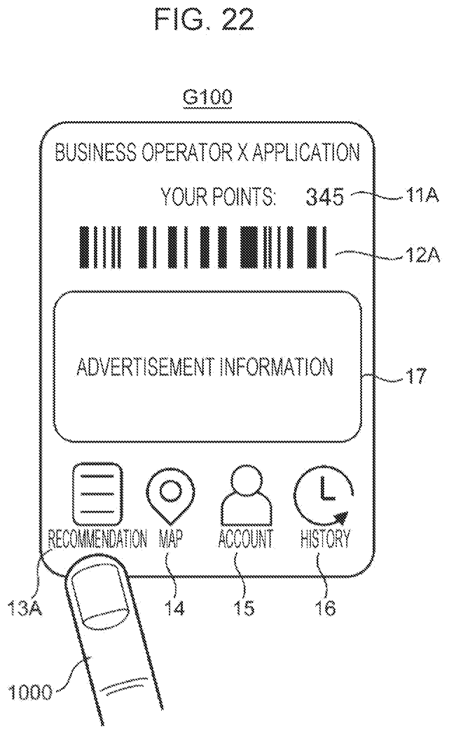

FIG. 22 is a diagram illustrating an example of the initial screen G100 in the second embodiment. The initial screen G100 is displayed on the display 105 when a user inputs an instruction to start the business operator X application to the information terminal 100. The initial screen G100 includes a point display field 11A, an authentication information display field 12A, and an advertisement display field 17.

The point display field 11A displays points of the business operator X application accumulated by the user. The authentication information display field 12A displays authentication information including information indicating whether the user is allowed to purchase a limited product at a special price. Here, a bar code is adopted as the authentication information. However, this is an example, and a QR code may also be adopted.

For example, the user presents the barcode to an employee of a store at the time of checkout of a product. The employee has the barcode reader read the authentication information. Thus, the store terminal 310 acquires the authentication information. The store terminal 310 analyzes the acquired authentication information and determines whether the corresponding user is allowed to purchase a limited product at a special price. If it is determined that the user is allowed to purchase a limited product at a special price, the store terminal 310 performs settlement of the limited product at the special price. On the other hand, if it is determined that the user is not allowed to purchase a limited product at a special price, the store terminal 310 performs settlement of the limited product at the normal price. In a case where products to be purchased by the user include products other than the limited product, the store terminal 310 may perform settlement for the limited product at the special price or the normal price depending on the user as described above, and may perform settlement for the rest of the products at the normal price.

Furthermore, the sales prices of some or all of the products may be individually changed in accordance with the authentication information of the user and/or the settlement time at the cash register. For example, a specific product may be discounted from the normal price only for a regular customer, or all products may be discounted from the normal price for all customers on a specific day of the week or immediately before the closing of the store.

Here, an example in which the authentication information is read by a scanner such as a barcode reader has been described. However, this is only an example. For example, the store terminal 310 may read the authentication information by short-range wireless communication such as NFC. In this case, the user may have the store terminal 310 read the authentication information by bringing the information terminal 100 close to a communication device of short-range wireless communication connected to the store terminal 310.

In the advertisement display field 17, an advertisement of a recommended product, service, or the like of the business operator X is displayed. The number of advertisement display fields may be one, or two or more.

In a lower part of the initial screen G100, a recommendation button 13A, the map button 14, the account button 15, and the history button 16 are provided. The recommendation button 13A is a button to be selected when displaying information related to a good deal recommended by the business operator X. Hereinafter, the selection operation is referred to as “touch”. The map button 14 is a button to be touched in order to check stores of the business operator X on a map around the current location. The account button 15 is a button to be touched when registering, checking, or updating a user account. The history button 16 is a button to be touched when referring to the user's past purchase history.

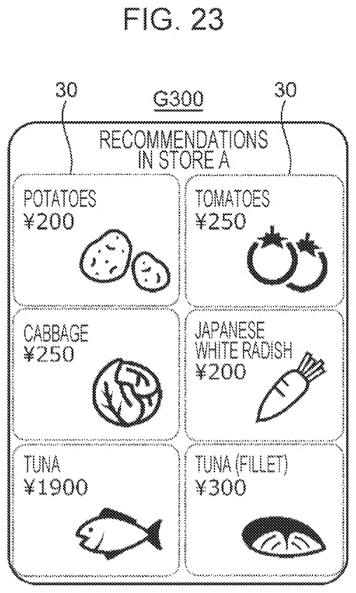

FIG. 23 is a screen diagram illustrating an example of a standard advertisement G300. On the standard advertisement G300, one or more products recommended to be purchased by the store A selected by the user are displayed. Here, since the store A is a supermarket, perishable foods are displayed on the standard advertisement G300. However, this is merely an example, and the standard advertisement G300 may include daily necessities, electric products, and the like. “Recommendations in Store A” is displayed in an upper part of the standard advertisement G300 to indicate that the standard advertisement G300 is an advertisement of the store A. On the standard advertisement G300, tile objects 30 corresponding to respective products recommended by the store A are displayed. Each of the tile objects 30 has a rectangular outer frame, and displays a product name, a price of the product, and an image indicating the product. Here, tile objects 30 corresponding to perishable foods such as potatoes and tomatoes are displayed. Unlike in the first embodiment, the tile objects 30 in the second embodiment do not accept a touch operation.

Although the tile objects 30 here are arranged in three rows x two columns, this is an example. In addition, the tile objects 30 have the same size. When a scroll operation is input on the standard advertisement G300, the information terminal 100 scrolls the standard advertisement G300 and displays tile objects 30 that have not been displayed on the display 105. Thus, the user can cause the display 105 to display tile objects 30 of products hidden on the initial screen of the standard advertisement G300.

The standard advertisement information includes layout information for specifying display positions of the tile objects 30 on the standard advertisement G300, a priority order of the products, image data of the tile objects 30, and the like. Therefore, the information terminal 100 may draw the standard advertisement G300 by arranging the tile objects 30 corresponding to the products in descending order of priorities in accordance with the layout information. The priority order of the products is defined in advance in the store A. For example, a more popular product may have a higher priority, or a product that the user has purchased more times in the past may have a higher priority. Here, the standard advertisement G300 may be different for each store or may be an advertisement common to all stores of the business operator X.

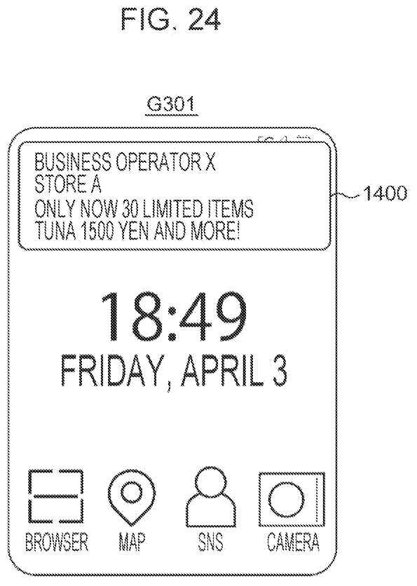

FIG. 24 is a diagram illustrating an example of a display screen G301 on which a push notification 1400 is displayed in the second embodiment. The push notification 1400 in the second embodiment is basically the same as that in the first embodiment. However, since an advertisement of a supermarket is displayed in the second embodiment, the push notification 1400 displays information briefly indicating the limited product sold in the supermarket. Here, since only 30 tunas are present as limited products in the store A, a product name, a price, and the like of the limited products are displayed in the push notification 1400. An image of the limited products may be displayed in the push notification 1400. In addition, in a case where a mode in which the push notification is displayed even if the limited products are sold out, which is described in FIGS. 21A and 21B, is adopted, a message indicating that there is a notification from the store A may be displayed in the push notification 1400.

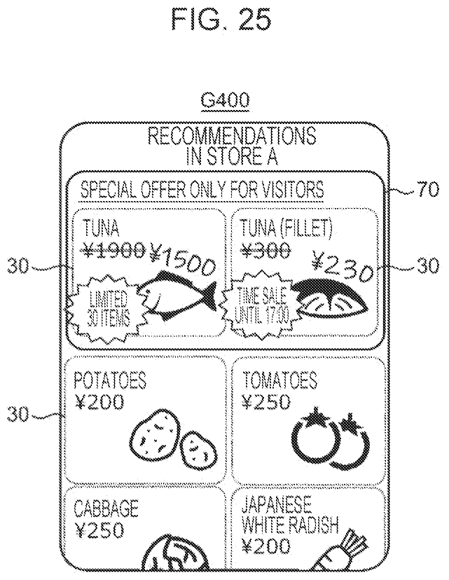

FIG. 25 is a screen diagram illustrating an example of a privileged advertisement G400. The privileged advertisement G400 is displayed when the user is near the store A at a timing when the user can purchase a limited product in the store A and when the user touches the push notification 1400. That is, at a timing immediately before the user displays the advertisement of the store A, the information terminal 100 of the user detects a beacon signal corresponding to the store A and displays, on the display 105, the push notification 1400 transmitted from the management server 200 in response to the detection. When the user touches the push notification 1400, the information terminal 100 transmits the store ID of the store A, “beacon reception: successful”, and the advertisement request in association with each other, or the unique ID of the push notification 1400, to the management server 200. Thus, the information terminal 100 receives the privileged advertisement information, and displays the privileged advertisement G400 on the display 105. This processing corresponds to steps S103 to S108 in FIG. 20A.

Unlike in the standard advertisement G300 illustrated in FIG. 23, a limited product field 70 indicating the current limited products of the store A is arranged in an upper part of the privileged advertisement G400. Thus, it is possible to appeal the presence of the limited products to the user in an easy-to-understand manner.

The width of the limited product field 70 is approximately twice the width of the tile object 30. Tile objects 30 indicating limited products are arranged in the limited product field 70. Here, two tile objects 30 indicating a tuna and a tuna fillet are arranged in the limited product field 70. In each of the tile objects 30, in addition to the product name of the limited product and the image indicating the limited product, the prices of the limited product before and after the discount are displayed. For example, in the tile object 30 of the tuna, a double line is drawn on 1900 yen, which is the normal price before the discount, and 1500 yen, which is the special price after the discount, is displayed adjacent to the normal price. Similarly, in the tile object 30 of the tuna fillet, a double line is drawn on 300 yen, which is the price before the discount, and 230 yen, which is the price after the discount, is displayed. Thus, the user can grasp the discount amounts of the limited products.

Furthermore, since the tuna is a limited product with a limited quantity, a message “limited 30 items” indicating that the quantity is limited is displayed in the tile object 30 of the tuna. Thus, the user can recognize that the quantity of the tuna is limited.

Furthermore, since the tuna fillet is a limited product with a limited purchase time, a message “time sale until 17:00” indicating that the purchase time is limited is displayed in the tile object 30 of the tuna fillet. Thus, the user can recognize that the purchase time of the tuna fillet is limited. A message indicating that the quantity is limited may be displayed in the tile object 30 of the limited product with a limited quantity, and a message indicating that the purchase time is limited may be displayed in the tile object 30 of the limited product with a limited purchase time.

Furthermore, a message stating “special offer only for visitors” is displayed in the limited product field 70. This message can cause the user to recognize the products displayed in the limited product field 70 are limited products presented only to users who visit the store A.

On the privileged advertisement G400, the standard advertisement is displayed below the limited product field 70. In the standard advertisement, as in the standard advertisement G300 illustrated in FIG. 23, the tile objects 30 are arranged according to the priority order of the products.

As in the standard advertisement G300, the privileged advertisement G400 is configured to be scrollable. Therefore, by performing a scroll operation, the user can cause tile objects 30 that have not been displayed on the initial screen of the privileged advertisement G400 to be displayed, and can browse an advertisement of low-priority products.

When there are three or more limited products, the three or more limited products are displayed in the limited product field 70 on the privileged advertisement G400. In this case, the information terminal 100 may display the tile objects 30 of the three or more limited products in the single limited product field 70, for example, in M rows x N columns on the privileged advertisement G400. Here, each of M and N is an integer of 1 or more. When there is a single limited product, the information terminal 100 may display the single limited product in the limited product field 70 on the privileged advertisement G400.

The privileged advertisement information transmitted from the management server 200 includes layout information indicating display positions of the limited product field 70, the tile objects 30, and the like, information for specifying the limited product, the priority order of the products, image data of the tile objects 30 corresponding to the products, and the like. Therefore, the information terminal 100 may draw the privileged advertisement G400 on the display 105 by arranging the limited product field 70 and the tile objects 30 in accordance with the layout information.

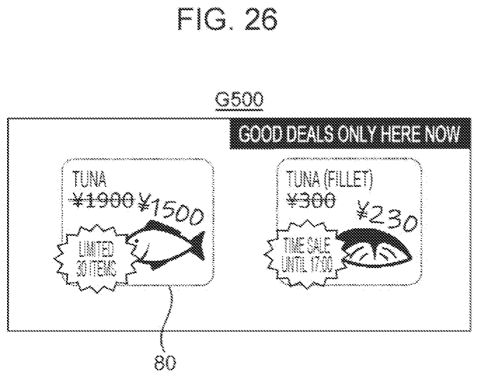

FIG. 26 is a diagram illustrating an example of an advertisement screen G500 displayed on the display device 320. The advertisement screen G500 is a screen for displaying an advertisement of the store A to users of the business operator X application who visit the store A. In this example, an advertisement of limited products is displayed on the advertisement screen G500. Currently, since the tuna and the tuna fillet are the limited products, tile objects 80 respectively corresponding to the tuna and the tuna fillet are displayed on the advertisement screen G500. The display content of the tile objects 80 is the same as that of the tile objects 30. Thus, users who visit the store A can check the limited products. A user who desires to purchase a limited product, for example, touches the push notification 1400 to cause the display 105 to display the privileged advertisement G400. Then, the user presents the initial screen G100 at the time of settlement of the limited product. Thus, the user can purchase the limited product at the special price.

Note that the user may be able to purchase a limited product without necessarily performing the above-described operation. For example, a QR code may be displayed in advance on the advertisement screen G500 and it is read by the information terminal 100, and thus, the authentication information for purchasing a limited product may be displayed on the display 105 of the information terminal 100 even if the business operator X application is not installed. Alternatively, for a user who has installed the business operator X application and has acquired the device ID of the beacon signal transmitter 330 installed in the store A, limited product information to be displayed on the display device 320 of the store A, or limited product information prepared for this user (which may be different from the limited product information to be displayed on the display device 320), may be displayed in the advertisement display field 17 on the initial screen G100 of the business operator X application at a timing when the business operator X application is started, and a limited product may be purchased at a special price.

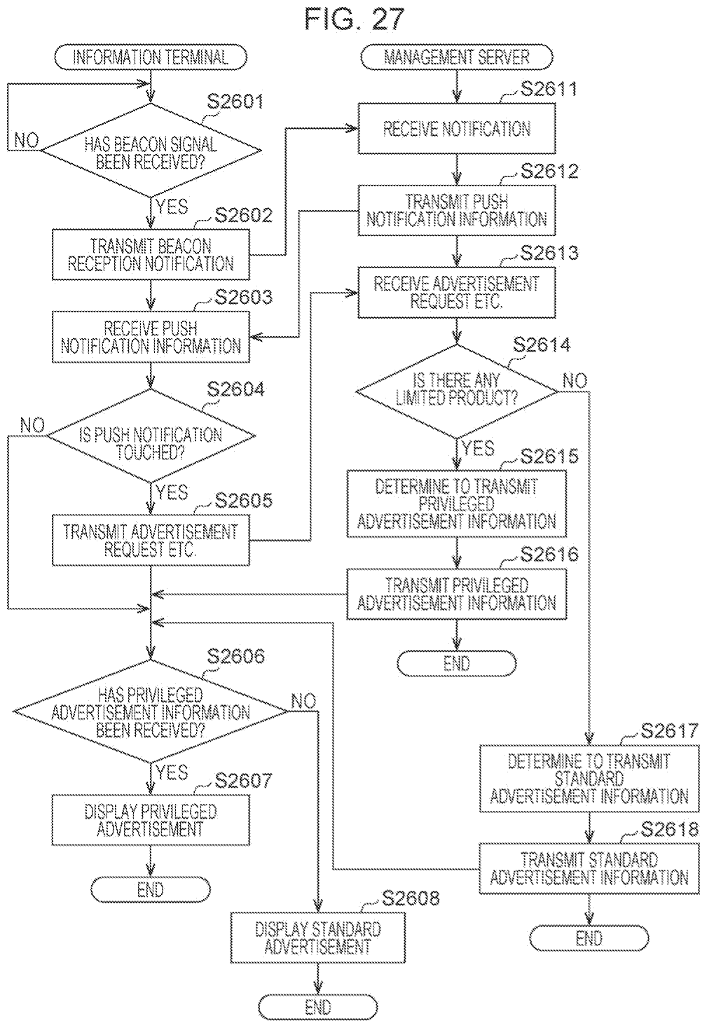

Next, the process performed by the information providing system according to the second embodiment will be described in detail. FIG. 27 is a flowchart illustrating details of the process performed by the information providing system according to the second embodiment. Note that this flowchart illustrates details of the process performed by the information providing system for a case where the mode described in FIGS. 21A and 21B is adopted, the mode displaying the push notification 1400 regardless of the presence or absence of the limited product.

The processing in steps S2601 to S2604 is the same as that in steps S1901 to S1904 in FIG. 19, and the processing in steps S2611 and S2612 is the same as that in steps S1911 and S1912 in FIG. 19.

In step S2605, since the push notification 1400 is touched (YES in step S2604), the calculation unit 104 transmits an advertisement request and the like to the management server 200 via the communication unit 101. The advertisement request and the like transmitted here may include the store ID of the store B, “beacon reception: successful”, and the advertisement request, or may include the unique ID corresponding to the push notification. The store ID of the store B is transmitted because the calculation unit 104 determines that the device ID included in the beacon signal received in step S2602 corresponds to the store ID of the store B by referring to the store dictionary.

Subsequently, the communication unit 201 of the management server 200 receives the advertisement request and the like (step S2613).

If it is determined in step S2614 that there is a limited product in the store B (YES in step S2614), the process proceeds to step S2615. If it is determined in step S2614 that there is no limited product in the store B (NO in step S2614), the process proceeds to step S2617.

In step S2615, the calculation unit 202 determines to transmit privileged advertisement information in which the limited product indicated by the limited product information is added to standard advertisement information of the store B. In step S2616, the calculation unit 202 transmits the privileged advertisement information of the store B to the information terminal 100 via the communication unit 201. In step S2617, the calculation unit 202 determines to transmit the standard advertisement information corresponding to the store B. In step S2618, the calculation unit 202 transmits the standard advertisement information of the store B to the information terminal 100 via the communication unit 201.

In step S2606, the calculation unit 104 of the information terminal 100 determines whether the privileged advertisement information has been received. If the privileged advertisement information has been received (YES in step S2606), the calculation unit 104 displays the privileged advertisement on the display 105 (step S2607). On the other hand, if the standard advertisement information has been received (NO in step S2606), the calculation unit 104 displays the standard advertisement on the display 105 (step S2608).

If the management server 200 not only transmits the advertisement information but also determines and transmits the display design thereof to the information terminal 100, the information terminal 100 may display the advertisement on the display 105 in accordance with the display design of the advertisement information received from the management server 200. In this case, the privileged advertisement information transmitted in step S2616 or the standard advertisement information transmitted in step S2618 may be directly displayed on the display 105 of the information terminal 100 in accordance with the designated design without performing the determination in step S2606. This can be easily realized by using Hypertext Markup Language (HTML), for example.

As described above, according to this embodiment, the limited product information indicating the limited product for which the time available for sale is limited is acquired, the push notification is displayed to a person who is within the reception range of the beacon signal from the store, and, in response to the advertisement request based on the push notification, the privileged advertisement including the limited product is displayed. Thus, it is possible to timely provide information about the limited product, which changes from moment to moment depending on stock or time, to a person in the store or in the vicinity of the store through the information terminal 100. As a result, food waste can be reduced.

Furthermore, according to this embodiment, the advertisement information is generated in response to the advertisement request corresponding to the store based on the push notification and is output to the information terminal 100. Therefore, the advertisement is prevented from being displayed on the information terminal 100 against the will of the user, and the user can be prevented from being bothered.

### Third Embodiment

In the first embodiment, the push notification information and the privileged purchase menu information are generated in advance triggered by the registration request for the limited product information. In a third embodiment, push notification information is generated each time a beacon reception notification is received, and privileged purchase menu information is generated each time a menu request and the like are received.

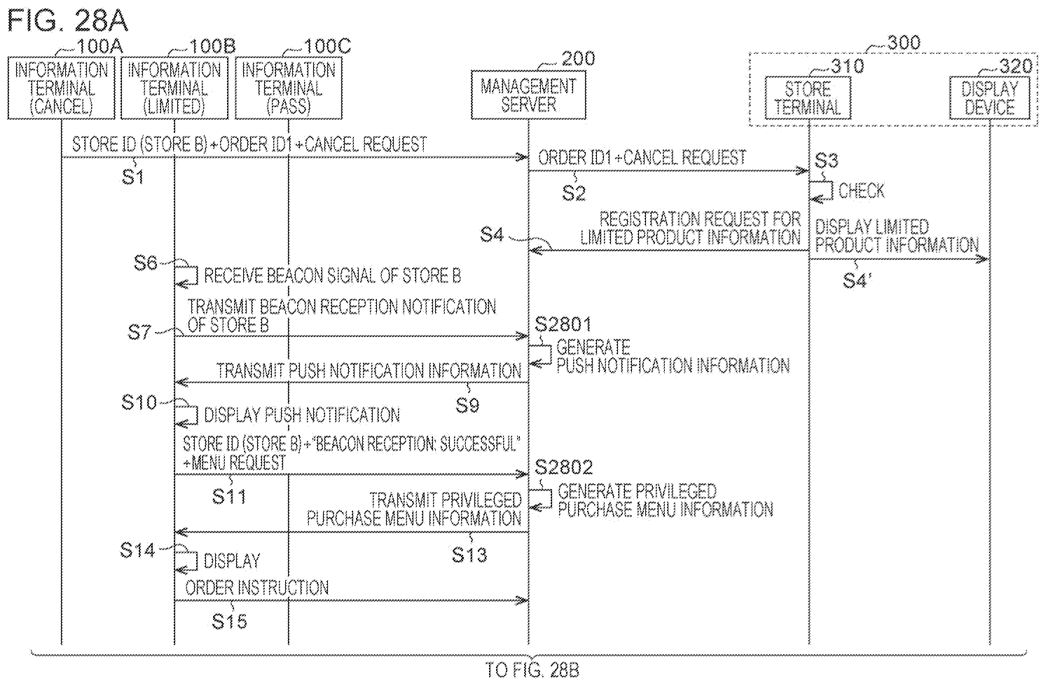

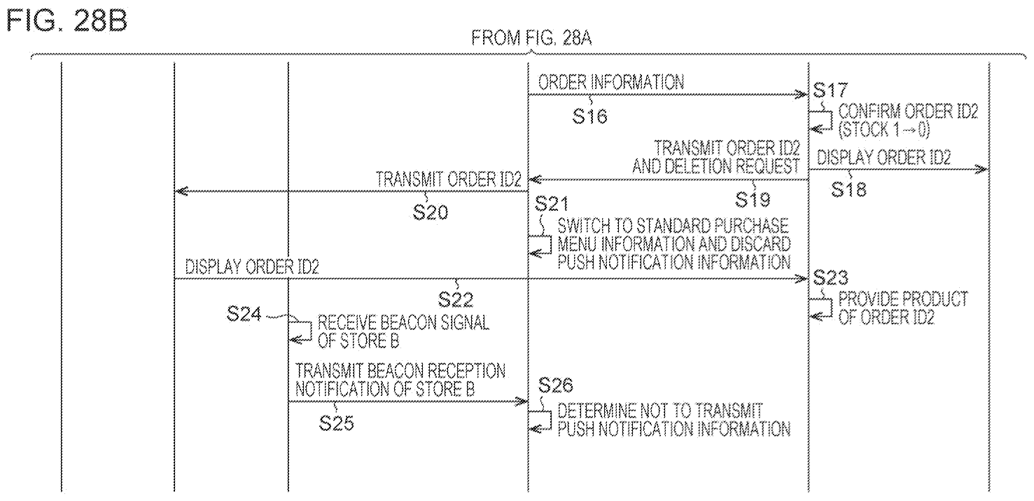

FIGS. 28A and 28B are a sequence diagram illustrating an example of a process performed by an information providing system according to the third embodiment. In FIGS. 28A and 28B, the same processing as that in FIGS. 6A and 6B is denoted by the same step number.

Having received the beacon reception notification of the store B, in step S2801, the management server 200 generates push notification information corresponding to the store B. Having received the store ID of the store B, “beacon reception: successful” indicating that the beacon signal corresponding to the store B has been successfully received, and the menu request, in step S2802, the management server 200 generates, based on the limited product information, privileged purchase menu information of the store B.

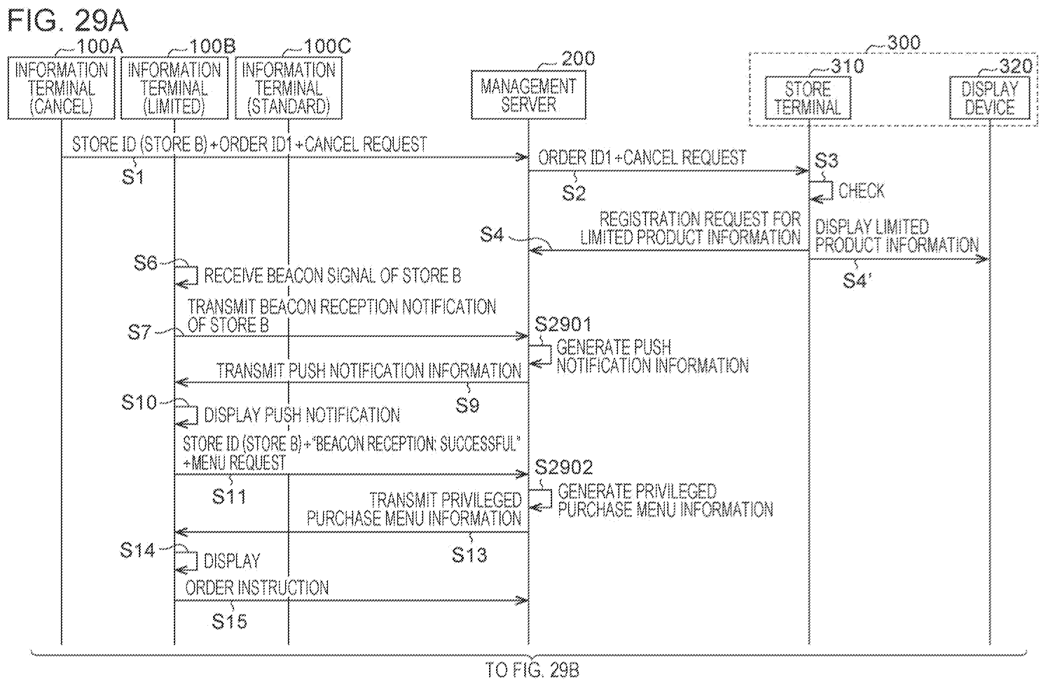

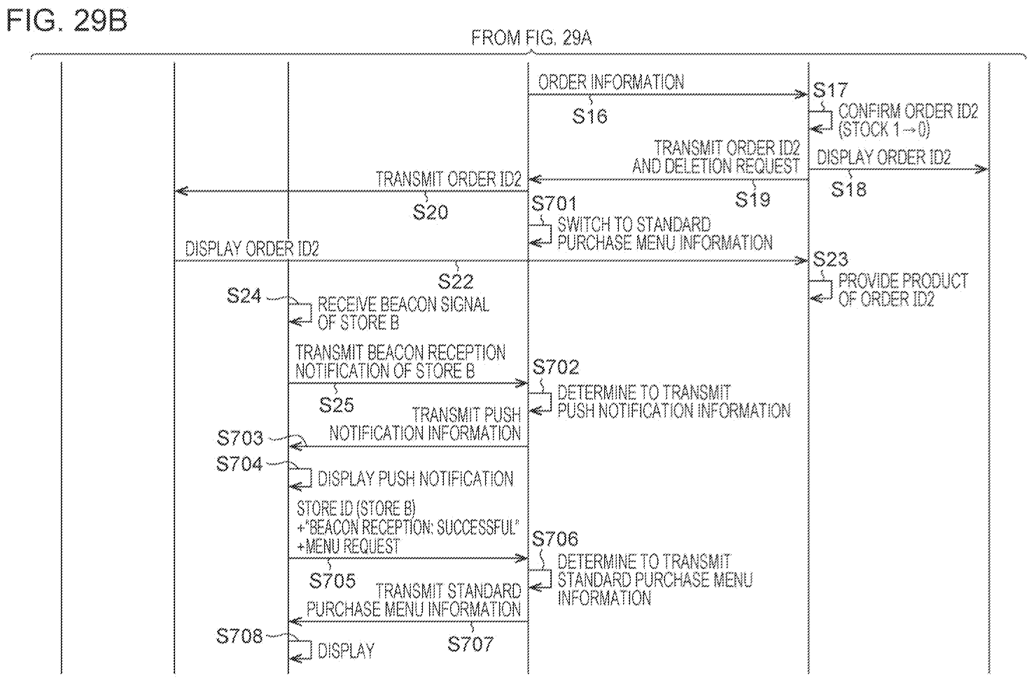

FIGS. 29A and 29B are a sequence diagram illustrating another example of the process performed by the information providing system according to the third embodiment. In FIGS. 29A and 29B, the same processing as that in FIGS. 7A and 7B is denoted by the same step number.

Having received the beacon reception notification of the store B, in step S2901, the management server 200 generates push notification information corresponding to the store B as in step S2801. Having received the store ID of the store B, “beacon reception: successful” indicating that the beacon signal corresponding to the store B has been successfully received, and the menu request, in step S2902, the management server 200 generates, based on the limited product information, privileged purchase menu information of the store B as in step S2802.

If the flowchart illustrated in FIG. 19 is applied to the third embodiment, the processing in step S1911 is “receive notification and generate push notification information”. In addition, the processing in step S1915 is “generate privileged purchase menu information”.

### Fourth Embodiment

In the second embodiment, the push notification information and the privileged advertisement information are generated in advance triggered by the registration request for the limited product information. In a fourth embodiment, push notification information is generated each time a beacon reception notification is received, and privileged advertisement information is generated each time an advertisement request and the like are received.

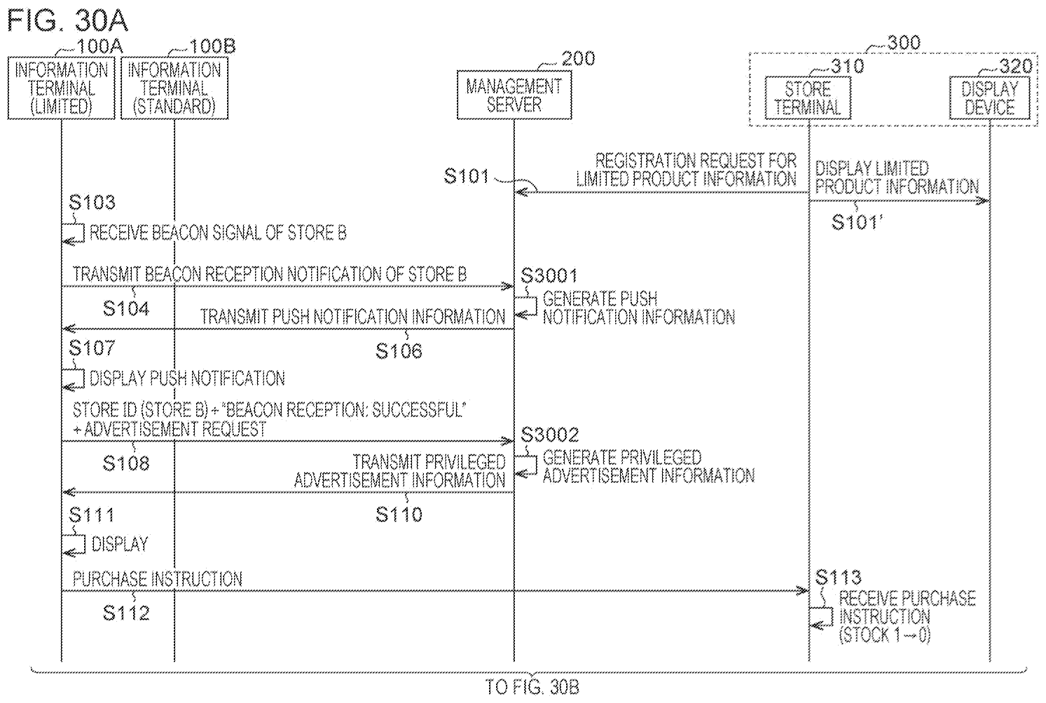

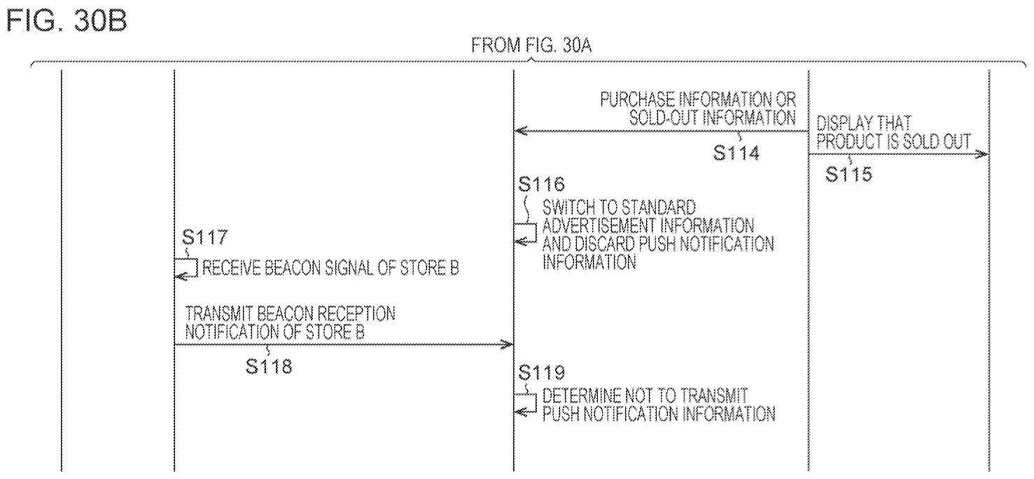

FIG. 30 is a sequence diagram illustrating an example of a process performed by an information providing system according to the fourth embodiment. In FIG. 30, the same processing as that in FIGS. 20A and 20B is denoted by the same step number.

Having received the beacon reception notification of the store B, in step S3001, the management server 200 generates push notification information corresponding to the store B. Having received the store ID of the store B, “beacon reception: successful” indicating that the beacon signal corresponding to the store B has been successfully received, and the advertisement request, in step S3002, the management server 200 generates, based on the limited product information, privileged advertisement information of the store B.

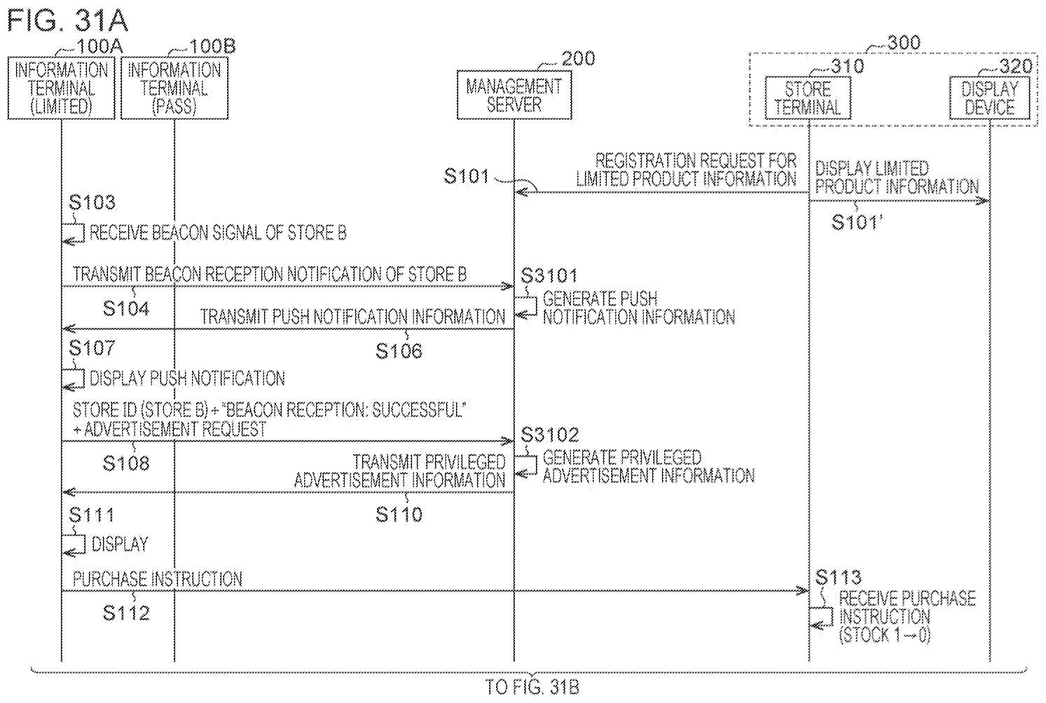

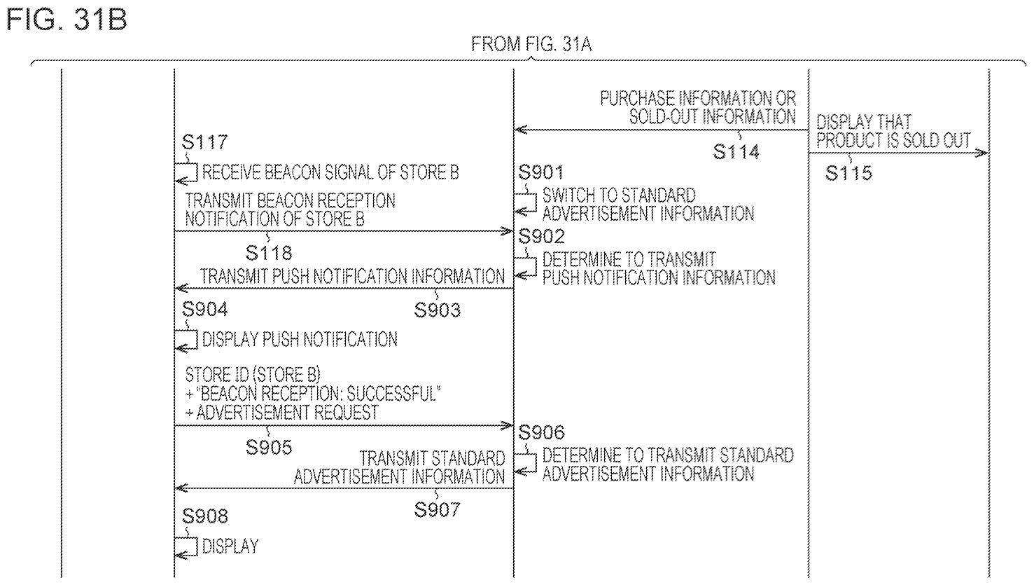

FIGS. 31A and 31B are a sequence diagram illustrating another example of the process performed by the information providing system according to the fourth embodiment. In FIGS. 31A and 31B, the same processing as that in FIGS. 21A and 21B is denoted by the same step number.

Having received the beacon reception notification of the store B, in step S3101, the management server 200 generates push notification information corresponding to the store B, as in step S3001. Having received the store ID of the store B, “beacon reception: successful” indicating that the beacon signal corresponding to the store B has been successfully received, and the advertisement request, in step S3102, the management server 200 generates, based on the limited product information, privileged advertisement information of the store B, as in step S3002.

If the flowchart illustrated in FIG. 27 is applied to the fourth embodiment, the processing in step S2611 is “receive notification and generate push notification information”. In addition, the processing in step S2615 is “generate privileged advertisement information”.

According to the present disclosure, it is possible to provide an information providing method useful in food service businesses such as fast-food stores, retail businesses such as supermarkets, and the like.

What is claimed is:

1. A method for a store management system connected to a store terminal, the method comprising:
acquiring, from the store terminal via a network, limited product information indicating a limited product for which a time available for sale in a store corresponding to the store terminal is limited;
acquiring, from a first communication terminal of a first user via the network, a request for a purchase menu corresponding to the store in which a beacon signal transmitter is disposed, wherein the first communication terminal within a reception range of a beacon signal transmitted from the beacon signal transmitter receives the beacon signal, the first communication terminal starts communication with the store management system in response to reception of the beacon signal, the first communication terminal receives a push notification corresponding to the store from the store management system, and the first communication terminal issues, based on the push notification, the request for the purchase menu corresponding to the store;
generating, based on the limited product information and the request for the purchase menu, privileged purchase menu information in which the limited product indicated by the limited product information is added to the purchase menu; and
outputting the privileged purchase menu information to the first communication terminal.

2. The method according to claim 1, further comprising:
acquiring, from the store terminal, sold-out information indicating that the limited product has been sold out in the store;
acquiring, from a second communication terminal of a second user, a request for the purchase menu corresponding to the store, wherein the second communication terminal within the reception range of the beacon signal receives the beacon signal, the second communication terminal starts communication with the store management system in response to reception of the beacon signal, the second communication terminal receives a push notification corresponding to the store from the store management system, and the second communication terminal issues, based on the push notification, the request for the purchase menu corresponding to the store; and
outputting, based on the sold-out information and the request for the purchase menu, standard purchase menu information corresponding to the store to the second communication terminal, the standard purchase menu information not including the limited product.

3. The method according to claim 1, wherein
the beacon signal includes a beacon identifier (ID), and the first communication terminal starts communication with the store management system using an application for communicating with the store management system corresponding to the beacon ID.

4. The method according to claim 1, wherein
the beacon signal includes a uniform resource locator (URL) for accessing the store management system, and the first communication terminal starts communication with the store management system using the URL.

5. The method according to claim 1, wherein
a monitor connected to the store terminal is disposed in the store, and
the limited product information is acquired from the store terminal in synchronization with a first instruction to display on the monitor the limited product information, the first instruction being output from the store terminal to the monitor.

6. The method according to claim 2, wherein
a monitor connected to the store terminal is disposed in the store, and
the sold-out information is acquired from the store terminal in synchronization with a second instruction to erase a display of the limited product information from the monitor, the second instruction being output from the store terminal to the monitor.

7. The method according to claim 1, wherein
the time available for sale is shorter than 24 hours.

8. A method for a store management system connected to a store terminal, the method comprising:
acquiring, from the store terminal via a network, limited product information indicating a limited product for which a time available for sale in a store corresponding to the store terminal is limited;
acquiring, from a first communication terminal of a first user via the network, a request for a purchase menu corresponding to the store in which a beacon signal transmitter is disposed, wherein the first communication terminal within a reception range of a beacon signal transmitted from the beacon signal transmitter receives the beacon signal, the first communication terminal starts communication with the store management system in response to reception of the beacon signal, the first communication terminal receives a push notification corresponding to the store from the store management system, and the first communication terminal issues, based on the push notification, the request for the purchase menu corresponding to the store;
generating, based on the limited product information, privileged purchase menu information in which the limited product indicated by the limited product information is added to the purchase menu; and
outputting, based on the request for the purchase menu, the privileged purchase menu information to the first communication terminal.

9. A method for a store management system connected to a store terminal, the method comprising:
acquiring, from the store terminal via a network, limited product information indicating a limited product for which a time available for sale in a store corresponding to the store terminal is limited;
acquiring, from a first communication terminal of a first user via the network, a request for an advertisement corresponding to the store in which a beacon signal transmitter is disposed, wherein the first communication terminal within a reception range of a beacon signal transmitted from the beacon signal transmitter receives the beacon signal, the first communication terminal starts communication with the store management system in response to reception of the beacon signal, the first communication terminal receives a push notification corresponding to the store from the store management system, and the first communication terminal issues, based on the push notification, the request for the advertisement corresponding to the store;
generating, based on the limited product information and the request for the advertisement, privileged advertisement information of the store, the privileged advertisement information including the limited product; and
outputting the privileged advertisement information to the first communication terminal.

10. The method according to claim 9, further comprising:
acquiring, from the store terminal, sold-out information indicating that the limited product has been sold out in the store;
acquiring, from a second communication terminal of a second user, a request for the advertisement corresponding to the store, wherein the second communication terminal within the reception range of the beacon signal receives the beacon signal, the second communication terminal starts communication with the store management system in response to reception of the beacon signal, the second communication terminal receives a push notification corresponding to the store from the store management system, and the second communication terminal issues, based on the push notification, the request for the advertisement corresponding to the store; and
outputting, based on the sold-out information and the request for the advertisement, standard advertisement information corresponding to the store to the second communication terminal, the standard advertisement information not including the limited product.

11. The method according to claim 9, wherein
the beacon signal includes a beacon ID, and the first communication terminal starts communication with the store management system using an application for communicating with the store management system corresponding to the beacon ID.

12. The method according to claim 9, wherein
the beacon signal includes a URL for accessing the store management system, and the first communication terminal starts communication with the store management system using the URL.

13. The method according to claim 9, wherein
a monitor connected to the store terminal is disposed in the store, and
the limited product information is acquired from the store terminal in synchronization with a first instruction to display on the monitor the limited product information, the first instruction being output from the store terminal to the monitor.

14. The method according to claim 10, wherein
a monitor connected to the store terminal is disposed in the store, and
the sold-out information is acquired from the store terminal in synchronization with a second instruction to erase a display of the limited product information from the monitor, the second instruction being output from the store terminal to the monitor.

15. The method according to claim 9, wherein
the time available for sale is shorter than 24 hours.

16. A method for a store management system connected to a store terminal, the method comprising:
acquiring, from the store terminal via a network, limited product information indicating a limited product for which a time available for sale in a store corresponding to the store terminal is limited;
acquiring, from a first communication terminal of a first user via the network, a request for an advertisement corresponding to the store in which a beacon signal transmitter is disposed, wherein the first communication terminal within a reception range of a beacon signal transmitted from the beacon signal transmitter receives the beacon signal, the first communication terminal starts communication with the store management system in response to reception of the beacon signal, the first communication terminal receives a push notification corresponding to the store from the store management system, and the first communication terminal issues, based on the push notification, the request for the advertisement corresponding to the store;
generating, based on the limited product information, privileged advertisement information of the store, the privileged advertisement information including the limited product; and
outputting, based on the request for the advertisement, the privileged advertisement information to the first communication terminal.
